(19) United States
(12) Patent Application Publication
(10) Pub. No.: US 2026/0269691 A1
(43) Pub. Date: Sep. 10, 2026

(54) LINEAR TRANSPORT SYSTEM AND METHOD FOR OPERATING A LINEAR TRANSPORT SYSTEM

(71) Applicant: Beckhoff Automation GmbH, Verl (DE)

(72) Inventors: Andreas Brinker, Bakum (DE); Manuel Bettenworth, Wien (AT); Jan Achterberg, Duisburg (DE); Matthias Pauli, Bad Wünnenberg (DE)

(21) Appl. No.: 19/664,398

(22) Filed: Apr. 30, 2026

Related U.S. Application Data
(63) Continuation of application No. PCT/EP2025/054106, filed on Feb. 14, 2025.

(30) Foreign Application Priority Data
Feb. 16, 2024 (DE) 102024104400.4

(51) Int. Cl. H02K 11/215; H02K 11/00; H02K 11/35; H02K 41/02

(52) U.S. Cl. CPC H02K 11/215; H02K 11/0094; H02K 11/35; H02K 41/02; H02K 2211/03

(57) ABSTRACT

A linear transport system includes a movable unit, a stationary unit having a guide rail for guiding the movable unit, a linear motor for driving the movable unit along the guide rail, and a position-detecting system. The position-detecting system has at least a first radio transmitting/receiving element and a second radio transmitting/receiving element. By reading out the identifying information provided by the first radio transmitting/receiving element or the second radio transmitting/receiving element via the respective other radio transmitting/receiving element, first position information regarding a position of the rotor relative to the stator can be determined, Taking the first position information into account, a position range regarding the positioning of the rotor relative to the stator can be determined. The application further relates to a computer-implemented method for operating a linear transport system.

### CROSS-REFERENCE TO RELATED APPLICATIONS

This application is a continuation of International patent application number PCT/EP2025/054106, filed Feb. 14, 2026, “Linear Transport System, and Method for Operating a Linear Transport System,” which claims the priority of German patent application DE 10 2024 104 400.4, filed Feb. 16, 2024, “Lineares Transportsystem und Verfahren zum Betreiben eines linearen Transportsystems,” each of which is incorporated by reference herein, in the entirety and for all purposes.

### FIELD

The application relates to a linear transport system. The application further relates to a method for operating a linear transport system.

### BACKGROUND

Linear transport systems are known from the prior art. In particular, linear transport systems are known that comprise a movable unit, a stationary unit having a guide rail for guiding the movable unit, and a linear motor for driving the movable unit along the guide rail, wherein the linear motor comprises a stator and a rotor, wherein the stator comprises a plurality of motor modules arranged in a stationary manner along the guide rail, each of which comprises a plurality of drive coils, wherein the rotor is arranged on the movable unit and comprises a plurality of magnets.

In order to control the movable unit along the guide rail, precise positioning of the movable unit relative to the guide rail is essential. In particular, for driving the drive coils of the stationary unit, exact positioning of the magnet assembly of the rotor of the movable unit relative to the drive coils of the stator of the stationary unit is important.

### SUMMARY

The application provides an improved linear transport system and a method for operating a linear transport system.

According to an aspect, a linear transport system is provided comprising a movable unit, a stationary unit having a guide rail for guiding the movable unit, a linear motor for driving the movable unit along the guide rail, and a position-detecting system, wherein the linear motor comprises a stator and a rotor, wherein the stator is embodied on the stationary unit and comprises a plurality of motor modules arranged in a stationary manner along the guide rail, each having drive coils and magnetic sensor elements, wherein the rotor is arranged on the movable unit and comprises a plurality of magnet elements, wherein the position-detecting system comprises at least a first radio transmitting/receiving element and a second radio transmitting/receiving element, wherein the first radio transmitting/receiving element is embodied at the rotor in a predefined first position, wherein the second radio transmitting/receiving element is embodied at the stator in a predefined second position, wherein the first radio transmitting/receiving element and the second radio transmitting/receiving element are each set up to provide and/or read out identifying information, wherein by reading out the identifying information provided by the first radio transmitting/receiving element or the second radio transmitting/receiving element via the respective other radio transmitting/receiving element, first position information regarding a position of the rotor relative to the stator may be determined, and wherein, taking the first position information into account, a position range regarding the positioning of the rotor relative to the stator may be determined.

### BRIEF DESCRIPTION OF THE DRAWINGS

This application is described in more detail with reference to the accompanying figures, which show:

FIG. 1 is a schematic top view of a linear transport system according to an embodiment;

FIG. 2 is a schematic depiction of a top view of a motor module of a stator of the linear transport system according to an embodiment;

FIGS. 3A and 3B are schematic depictions of the positioning of a rotor relative to the stator of the linear transport system according to an embodiment;

FIG. 4 is a schematic depiction of a rotor of the linear transport system according to an embodiment;

FIG. 5 is a further schematic depiction of a rotor of the linear transport system according to an embodiment;

FIGS. 6A and 6B are schematic depictions of a position-detecting system according to an embodiment;

FIG. 7 is a schematic depiction of a magnetic field measurement of the magnetic fields of the magnet elements of the rotor;

FIG. 8 is a schematic depiction of an absolute position determination according to a first embodiment;

FIG. 9 is a schematic depiction of an absolute position determination according to a second embodiment;

FIG. 10 is a flowchart of a method for operating a linear transport system according to an embodiment;

FIG. 11 is a further flowchart of the method for operating a linear transport system according to a further embodiment;

FIG. 12 is a further flowchart of the method for operating a linear transport system according to a further embodiment;

FIG. 13 is a further flowchart of the method for operating a linear transport system according to a further embodiment;

FIG. 14 is a further flowchart of the method for operating a linear transport system according to a further embodiment; and

FIG. 15 is a further flowchart of the method for operating a linear transport system according to a further embodiment.

In the following, the same reference numerals may be used for elements having the same function. In such cases, these elements may not be described again for each figure. Nevertheless, these elements having the same function may be provided accordingly in all embodiments.

### DETAILED DESCRIPTION

This application may achieve the technical advantage of providing an improved linear transport system having improved position determination of a moving unit relative to a stationary unit. For this purpose, the linear transport system comprises a position-determining system. The position-determining system comprises at least a first radio transmitting/receiving element embodied at the rotor and at least a second radio transmitting/receiving element embodied at the stator.

The first and second radio transmitting/receiving elements are set up to exchange identifying information with one another via a wireless radio connection. The identifying information uniquely identifies the first or second radio transmitting/receiving element providing the identifying information. Since the first radio transmitting/receiving element is embodied at a predetermined first position at the rotor and the second radio transmitting/receiving element is embodied at a predetermined second position at the stator, first position information regarding a position of the rotor relative to the stator may be determined via wireless data communication between the first and second radio transmitting/receiving elements of the position-determining system.

In this context, the first position information defines a position range in which the rotor is located relative to the stator. The position range extends along a longitudinal axis of the rotor or stator. The position range of the first position information may thus serve for roughly determining the position of the rotor relative to the stator. Based on the first position information, an exact determination of the position of the rotor relative to the stator may be carried out in subsequent steps, taking additional information into account.

The position determination may be carried out by a controller of the linear transport system. The controller knows the first position of the first radio transmitting/receiving element at the rotor and the second position of the second radio transmitting/receiving element at the stator. As soon as identifying information is provided by the first or second radio transmitting/receiving element and received by the respective other radio transmitting/receiving element, the controller may thus determine that the predefined first position at the rotor is located within the position range of the first position information relative to the predefined second position at the stator. In this context, the position range may be defined as a range in which the first radio transmitting/receiving element and the second radio transmitting/receiving element are arranged in an effective coupling with one another and data communication between the first radio transmitting/receiving element and the second radio transmitting/receiving element is allowed for.

Taking into account the first position information from the position-determining system allows for reliably and robustly determining the position of the rotor relative to the stator. The radio-based data communication between the first radio transmitting/receiving element and the second radio transmitting/receiving element is highly robust and insensitive to external interference. Furthermore, the radio-based position-determining system represents a cost-effective solution for determining the position of the rotor relative to the stator and, consequently, the position of the moving unit relative to the stationary unit.

Position determination by the position-determining system may, for example, be carried out while the moving unit is held at a holding position relative to the stationary unit. The results of the position determination by the position-determining system, i.e. the position range of the first position information, may serve as an initial value for further position determinations carried out, for example, during the movement of the movable unit along the guide rail of the stationary unit, based on other technical solutions for position determination.

The stationary unit is equipped with a position scale extending along the longitudinal axis that defines absolute position values. According to the application, the position determination of the rotor relative to the stator refers to a position determination of the respective movable unit relative to the stationary unit. This position determination of the movable unit relative to the stationary unit is defined by the positioning of the movable unit relative to the position scale of the stationary unit. A position of the rotor relative to the stator, or of the movable unit relative to the stationary unit, is in this context defined by a position value on the position scale of the stationary unit.

Positions on the position scale of the stationary unit are assigned to the individual motor modules of the stator, and positions on the motor modules along the longitudinal axis correspond to positions on the position scale of the stationary unit.

### Examples

According to an embodiment, a second position signal regarding the position of the rotor relative to the stator may be determined by measuring the magnetic field strengths of the magnet elements of the rotor with the aid of at least one magnetic sensor element of the stator, and wherein an absolute position of the rotor relative to the stator may be determined by taking into account the first position signal and the second position signal.

This provides the technical advantage of enabling precise position determination of the rotor relative to the stator. By taking into account the first and second position information, a unique position determination of the rotor relative to the stator may be achieved, taking into account the information from the position-determining system and the information from the magnetic field measurements of the magnetic fields of the magnet element of the rotor by the stator's magnetic field sensors.

According to the application, the absolute position of the rotor relative to the stator corresponds to an absolute position of the respective moving unit relative to the stationary unit and is defined by a position value on the position scale of the stationary unit.

According to an embodiment, the position-determining system is configured as a near-field communication system, wherein the first radio transmitting/receiving element and the second radio transmitting/receiving element are each configured as a near-field communication transmitting/receiving element or as a near-field communication reading element.

This may achieve the technical advantage of enabling a precise, robust, and cost-effective positioning system. The use of near-field communication technology allows for cost-effective manufacturing and robust, reliable operation of the positioning system.

Position determination is carried out in such a way that, as soon as the first radio transmitting/receiving element and the second radio transmitting/receiving element are each positioned within a transmitting/receiving range of each other, one of the radio transmitting/receiving elements automatically transmits a query to the other radio transmitting/receiving element to provide the identifying information. The respective other radio transmitting/receiving element receiving the request is thereby activated and provides the requested identifying information to the requesting radio transmitting/receiving element.

Furthermore, due to the short range of the near-field communication between the first and second radio transmitting/receiving elements, it may be ensured that corresponding data communication primarily takes place when the radio transmitting/receiving elements are arranged substantially directly opposite one another. This facilitates position determination, since, upon receipt of the identifying information by one of the two radio transmitting/receiving elements, it may be assumed that the movable unit is positioned relative to the stationary unit in such a way that the first radio transmitting/receiving element and the second radio transmitting/receiving element—and thus the predetermined first and second positions at the rotor and the stator—are arranged directly opposite with regard to one another.

The determination of the position of the rotor relative to the stator, or of the movable unit relative to the stationary unit, is subsequently obtained by determining the first position within the rotor or the movable unit and the predetermined second position within the stator or the stationary unit, and the relative arrangement of the first and second positions with respect to one another. This enables precise, robust, and cost-effective position determination.

According to an embodiment, the position-determining system comprises a plurality of first radio transmitting/receiving elements and/or second radio transmitting/receiving elements, wherein the first radio transmitting/receiving elements are each embodied at predefined first positions at the rotor and/or the second radio transmitting/receiving elements are embodied at predefined second positions at the stator.

This may achieve the technical advantage that, by forming a plurality of first radio transmitting/receiving elements at the rotor and/or a plurality of second radio transmitting/receiving elements at the stator, position determination may be further refined and simplified. The first radio transmitting/receiving elements and/or the second radio transmitting/receiving elements each comprise individual identifying information, with the aid of which the individual first and/or second radio transmitting/receiving elements may be uniquely identified.

Moreover, the first radio transmitting/receiving elements are arranged at the rotor at individual predetermined first positions, and/or the second radio transmitting/receiving elements are arranged at the stator at predefined second positions. For each first and second radio transmitting/receiving element, the controller thus knows a unique position at the rotor or at the stator. Since the first and/or second radio transmitting/receiving elements may be uniquely identified via the individual identifying information, and since the respective positions of each first and second radio transmitting/receiving element at the rotor and/or at the stator are known in advance to the controller, the above-described position determination of the rotor relative to the stator may thus be carried out via each of the plurality of first and second radio transmitting/receiving elements.

Regardless of the positioning of the movable unit relative to the stationary unit, position determination may be carried out immediately as soon as at least one first and one second radio transmitting/receiving element are arranged within transmitting and receiving range of each other, respectively, and communication may thus take place between the pair of first and second radio transmitting/receiving elements. Using the individual identifying information provided by the first and/or second radio transmitting/receiving elements, the controller is able to identify the radio transmitting/receiving elements communicating in pairs with one another and to determine the first or second positions at the rotor or stator, respectively, designated for the first and second radio transmitting/receiving elements.

In accordance with the procedure described above, a relative position determination of the rotor relative to the stator or of the movable unit relative to the stationary unit may then be carried out. By using a plurality of first and/or second radio transmitting/receiving elements, which are advantageously arranged, for example along a longitudinal direction of the movable unit and/or of the stationary unit, at the rotor or the stator, respectively, the position of the moving unit relative to the stationary unit may be determined whenever the first and second radio transmitting/receiving elements are arranged in pairs within the transmitting or receiving range of one another. This eliminates the need for any special alignment of the moving unit relative to the stationary unit to carry out the position determination.

According to an embodiment, the first radio transmitting/receiving elements are each set up to provide identifying information that may be read by the second radio transmitting/receiving element and is characteristic of the respective first radio transmitting/receiving element, and/or wherein the second radio transmitting/receiving element is set up to provide identifying information readable by the first radio transmitting/receiving elements and characterizing the respective second radio transmitting/receiving element, and wherein the characteristic identifying information allows for uniquely identifying the respective first radio transmitting/receiving element or second radio transmitting/receiving element.

This may achieve the technical advantage that the plurality of first and/or second radio transmitting/receiving elements may be uniquely identified by the characteristic identifying information. The unique identification of the radio transmitting/receiving elements communicating with one another allows for unambiguously determining the position of the rotor relative to the stator.

In an embodiment, the first radio transmitting/receiving elements may be individually read by the second radio transmitting/receiving elements and/or the second radio transmitting/receiving elements may be individually read by the first radio transmitting/receiving elements.

This may achieve the technical advantage that precise position determination is allowed for by the individual reading of the first radio transmitting/receiving elements by the second radio transmitting/receiving elements and/or of the second radio transmitting/receiving elements by the first radio transmitting/receiving elements. Since the reading between the first and second radio transmitting/receiving elements occurs only in pairs and the corresponding characteristic identifying information is provided only in pairs, the controller may unambiguously determine the relative position of the rotor with respect to the stator based on the first and second predetermined positions of the first and second radio transmitting/receiving elements at the rotor and the stator, respectively. Through the paired communication and paired reading of the first and second radio transmitting/receiving elements with each other, faulty or ambiguous data communication between the first and second radio transmitting/receiving elements may be prevented.

According to an embodiment, the first radio transmitting/receiving elements are arranged side by side at the rotor along a longitudinal axis of the movable unit.

This may achieve the technical advantage that, by arranging the plurality of first radio transmitting/receiving elements along the longitudinal axis of the movable unit, the position of the movable unit relative to the stationary unit may be determined at any position of the movable unit relative to the stationary unit. By arranging the plurality of first radio transmitting/receiving elements side by side along the longitudinal axis of the movable unit, the probability is increased that, for any positioning of the movable unit relative to the stationary unit, one of the plurality of first radio transmitting/receiving elements is located within the transmitting or receiving range of at least one second radio transmitting/receiving element of the stator. A specific positioning of the movable unit relative to the stationary unit for carrying out position determination is therefore not necessary.

According to an embodiment, along the longitudinal axis, a distance between two adjacent first radio transmitting/receiving elements is smaller than a minimum distance between two magnet elements with the same magnetic polarity, and/or wherein a width of the first radio transmitting/receiving elements along the longitudinal axis is smaller than the minimum distance between two magnet elements with the same magnetic polarity.

This may achieve the technical advantage that due to the distances between adjacent first radio transmitting/receiving elements and/or the size of the first transmitting/receiving elements being smaller than the minimum distance between magnet elements of the rotor having the same magnetic polarity, unambiguous position determination when determining the position of the rotor relative to the stator via a magnetic field measurement of the magnetic fields of the magnetic units of the rotor is allowed for by taking into account the position information obtained through the position determination by the position-determining system.

According to the application, the magnet elements of the rotor are arranged along the longitudinal axis of the moving unit in an alternating pattern with opposite magnetic polarities. The magnetic fields of the magnet elements having the same polarity are essentially identical, so that measuring the magnetic fields does not allow for unambiguously determining which magnet element of the rotor the measured magnetic field belongs to. Thus, measuring the magnetic fields of the magnet elements of the rotor does not allow for unambiguously determining the position of the rotor relative to the stator.

However, by now taking into account the position information previously determined by the position-detecting system based on the identifying information of the first and/or second radio transmitting/receiving elements, it is possible to unambiguously determine, based on the measured magnetic field strengths of the magnet elements of the rotor, to which magnet element the respective measured magnetic field belongs. However, this requires that the distances between two adjacent first and/or second radio transmitting/receiving elements and/or the size of the first and/or second radio transmitting/receiving elements be at least smaller than the smallest distance between two adjacent magnet elements having the same magnetic polarity.

If the distance between directly adjacent first and/or second radio transmitting/receiving elements is smaller and/or if the size of the first and/or second radio transmitting/receiving elements is smaller than the smallest distance between two magnet elements with the same magnetic polarity, the respective magnet element may be uniquely identified when measuring a magnetic field with a specific magnetic polarity based on the position information from the position-determining system.

If, during positioning of the rotor relative to the stator, a magnetic field of one of the magnet element of the rotor is detected by a magnetic field sensor in the stator and, simultaneously, identifying information of a respective other second or first radio transmitting/receiving element is received by a first or second radio transmitting/receiving element of the position-determining system, the respective first or second radio transmitting/receiving element providing the identifying information may be uniquely identified by the identifying information. Since the controller knows the positions of the respective first and second radio transmitting/receiving elements and the position of the magnetic sensor element via which the magnetic field of the respective magnet element was measured, the magnetic field measured by the magnetic sensor element may be unambiguously assigned to a magnet element of the rotor.

The ambiguity of the magnetic field measurements of the magnet element of the rotor may thus be resolved by the position information from the position-determining system. Consequently, by combining the information from the position-determining system with the magnetic field measurements of the magnet element of the rotor, a unique determination of the position of the rotor relative to the stator, or of the moving unit relative to the stationary unit, may be achieved.

According to an embodiment, the first radio transmitting/receiving elements are arranged in two spaced-apart rows at the rotor, with the magnet element of the rotor arranged in a region between the two spaced-apart rows.

This may achieve the technical advantage that, due to the two rows of first radio transmitting/receiving elements at the rotor, each of which is arranged along the longitudinal axis of the moving unit, communication between the first radio transmitting/receiving elements of the rotor and the second radio transmitting/receiving elements of the stator is allowed for even when the rotor or the moving unit reverses its direction of motion relative to the stationary unit, without requiring an increase in the number of second radio transmitting/receiving elements at the stator.

If the movable unit is mounted on the guide rail of the stationary unit in a first orientation, the second radio transmitting/receiving element mounted at the stator of the stationary unit may read the first radio transmitting/receiving elements of one row at the rotor. If, on the other hand, the movable unit is mounted on the guide rail of the stationary unit in the opposite orientation, the same second radio transmitting/receiving element may read the first radio transmitting/receiving elements of the respective other row at the rotor.

By configuring the first radio transmitting/receiving elements in the two rows at the rotor, the same second radio transmitting/receiving element may thus be used to read the first radio transmitting/receiving elements of the rotor for both orientations of the movable unit relative to the stationary unit. This allows for eliminating components in the form of the second radio transmitting/receiving elements, which allows for more cost-effective and energy-efficient manufacturing of the linear transport system.

In an embodiment, the first radio transmitting/receiving elements and/or the magnet elements are arranged on a common printed circuit board.

This may provide the technical advantage that the configuration of the first radio transmitting/receiving elements and the magnet elements of the rotor on a common printed circuit board allows for simplified manufacturing of the rotor of the movable unit.

In an embodiment, at least a further functional module is embodied in the printed circuit board, wherein the functional module is one from the following list: a control module for energy transmission between the movable unit and the stationary unit, a control module for controlling an application on the movable unit, a control module for controlling data communication between the movable unit and the stationary unit.

This may achieve the technical advantage that, by embodying additional functional modules in the printed circuit board, additional functions of the rotor may be integrated into the printed circuit board. This further simplifies the manufacture of the rotor.

According to an embodiment, the printed circuit board further includes at least one energy-transmitting coil for energy transmission between the mobile unit and the stationary unit.

This may achieve the technical advantage that the formation of an energy-transmitting coil in the printed circuit board further allows for transmitting energy between the mobile unit and the stationary unit. Since the energy-transmitting coil is directly integrated into the printed circuit board, this further simplifies the manufacture of the rotor.

According to an embodiment, the first radio transmitting/receiving element comprises an identification code readable by the second radio transmitting/receiving element, wherein the mobile unit may be uniquely identified via the identification code.

This may achieve the technical advantage that the identification code of the first radio transmitting/receiving element, by reading it out via the second radio transmitting/receiving element of the stator—which is in active coupling with the first radio transmitting/receiving element—during position determination by the position-detecting system, a unique identification of the respective rotor or the respective movable unit may be achieved. When multiple moving units are in operation on the guide rail of the stationary unit, the position-determining system may thus additionally provide a unique identification of the respective rotor or the respective moving unit during position determination. This facilitates the operation of the linear transport system and further refines the position determination of the moving units relative to the stationary unit.

According to a further aspect, a computer-implemented method for operating a linear transport system according to any one of the preceding embodiments is provided, wherein the method comprises:
receiving identifying information of the respective other radio transmitting/receiving element read out by the first radio transmitting/receiving element or the second radio transmitting/receiving element via the controller of the linear transport system in a receiving step; and
determining first position information regarding a position of the rotor relative to the stator based on the identifying information via the controller in a first position information determining step, wherein the first position information defines a position range regarding the positioning of the rotor relative to the stator.

This may achieve the technical advantage of providing an improved method for operating a linear transport system with the technical advantages described above.

For this purpose, the controller of the linear transport system first receives identifying information from the first radio transmitting/receiving element or the second radio transmitting/receiving element of the position-detecting system. Based on this identifying information, the controller determines a first position. The first position information is based exclusively on the information from the position-determining system. The first position information defines a position range with respect to the positioning of the rotor relative to the stator. Based on the first position information, a rough position determination of the rotor relative to the stator may thus be carried out, in which a position range is determined in which the rotor is located relative to the stator. The position range extends along the longitudinal axis of the rotor and/or the stator. Based on the position range, an absolute position of the rotor relative to the stator may be determined in further method steps.

According to an embodiment, the method further comprises:
determining an absolute position of the rotor relative to the stator taking into account the first position information via the controller in an absolute position determining step.

This may achieve the technical advantage that the method for controlling the linear transport system allows for determining an absolute position of the rotor relative to the stator, or of the movable unit relative to the stationary unit. The absolute position describes the absolute positioning of the movable unit relative to the stationary unit and refers to a reference coordinate system connected to the movable unit. The absolute position is the position information of the movable unit relative to the stationary unit, or of the rotor of the movable unit relative to the stator of the stationary unit, which may be used for further control of the linear drive system.

According to an embodiment, the method further comprises:
receiving magnetic sensor data from at least one magnetic sensor element regarding magnetic field strengths of at least one magnet element of the rotor via the controller in a further receiving step;
determining second position information regarding the positioning of the rotor relative to the stator based on the magnetic sensor data via the controller in a second position information determining step;
determining the absolute position of the rotor relative to the stator based on the first position information and the second position information via the controller in the absolute position determining step.

This may achieve the technical advantage of allowing for further refining of the absolute position of the moving unit relative to the stationary unit. For this purpose, the absolute position is calculated taking into account a second set of position information in addition to the first set of position information from the position-determining system. The second position information is in this context calculated by taking into account magnetic sensor data representing the rotor magnetic field of the magnetic units of the rotor, obtained from at least one magnetic sensor element embodied at the stator. The magnetic sensor data of the rotor magnetic fields of the magnet element of the rotor allows for precise positioning of the respective magnetic sensor element of the stator relative to the magnetic units of the rotor.

By taking the magnetic sensor data in the form of the second position information into account when calculating the absolute position relative to the stator or the moving unit relative to the stationary unit, a substantial improvement in the precision of the position determination of the moving unit relative to the stationary unit may thus be achieved compared to the first position range of the first position information determined based on the information from the position-determining system. This allows for more precise position determination and more precise control of the drive system.

According to an embodiment, the first position information defines a first relative position between the first radio transmitting/receiving element and the second radio transmitting/receiving element, wherein the second position information defines a second relative position of at least one magnetic sensor element of the stator relative to at least one magnet element of the rotor.

This may achieve the technical advantage of simplifying the determination of the position of the moving unit relative to the stationary unit. For this purpose, the first position information defines a first relative position between the first radio transmitting/receiving element and the second radio transmitting/receiving element. The second position information, on the other hand, defines a second relative position in which at least one magnetic sensor element of the stator is positioned relative to at least one magnet element of the rotor.

The measurements of the position-determining system thus allow for determining the first relative position between the first and second radio transmitting/receiving elements of the rotor and the stator, respectively, which communicate with each other via data communication. Further positioning information may be provided via the measurements of the rotor magnetic field by the at least one magnetic sensor element of the stator. This describes a relative positioning between a magnetic sensor element and a magnet element of the rotor measured by the magnetic sensor element. By taking into account the two relative positions of the first and second radio transmitting/receiving elements relative to each other, as well as the relative position between the magnet elements of the rotor and the magnetic sensor elements of the stator, an absolute position determination of the moving unit relative to the stationary unit may thus be achieved.

In an embodiment, the first relative position corresponds to a position at the rotor that is the projection onto the rotor of the second radio transmitting/receiving element embodied at the second position at the stator, and is defined by a first position region extending along the longitudinal axis of the rotor and arranged around the first position, wherein the first position range defines a spatial range in which the first radio transmitting/receiving element arranged at the first position at the rotor and the second radio transmitting/receiving element arranged at the second position at the stator are in mutual effective coupling with each other, and/or wherein the second relative position corresponds to a position at the rotor of a projection onto the rotor of the magnetic sensor element embodied at a magnetic sensor position at the stator.

This may achieve the technical advantage of allowing for a further simplification of position determination. For this purpose, the first relative position between the first and second radio transmitting/receiving elements communicating with each other is defined as a projection onto the rotor of the second radio transmitting/receiving element, which is embodied in the second position at the rotor and participates in data communication. The first relative position is further described by the first position range, which is arranged around the first position of the first radio transmitting/receiving element participating in data communication at the rotor. The first position range is defined here by a spatial region in which the first and second radio transmitting/receiving elements communicating with each other are in effective coupling with one another. The first position range of the first position information thus takes into account the transmission-reception range of the first and second radio transmitting elements communicating with each other. This may simplify the determination of the position of the mobile unit relative to the stationary unit.

According to an embodiment, the first position information determining step comprises:
identifying the first radio transmitting/receiving element based on the identifying information by the controller in an identifying step;
determining the predefined first position at the rotor of the first radio transmitting/receiving element identified in the identifying step and determining the predefined second position at the stator of the second radio transmitting/receiving element via the controller in a position determining step; and
determining the first relative position of the first radio transmitting/receiving element embodied at the first position relative to the second radio transmitting/receiving element embodied at the second position at the stator, taking into account the first and second positions and the first position range, via the controller in a first relative position determining step.

This may achieve the technical advantage of allowing for further simplifying position determination. For this purpose, the first radio transmitting/receiving element of the rotor communicating with the second radio transmitting/receiving element of the stator is first identified based on the identifying information exchanged during data communication. The identifying information allows for uniquely identifying the first and second radio transmitting/receiving elements communicating with each other.

Furthermore, to determine the first position information, the first and second positions of the first and second radio transmitting/receiving elements communicating with each other at the rotor and at the stator, respectively, are determined. The controller of the linear transport system is aware of the first positions of the first radio transmitting/receiving elements embodied at the rotor and the second positions of the second radio transmitting/receiving elements embodied at the stator. By identifying the first and second radio transmitting/receiving elements communicating with one another through the reading of the identifying information exchanged during data communication, the controller may thus determine the corresponding first and second positions at the rotor and stator, respectively, of the first and second radio transmitting/receiving elements communicating with one another.

The controller further knows, for each first radio transmitting/receiving element, the first position range assigned to the respective first radio transmitting/receiving element. The first position range defines a spatial region arranged around the first position of the respective first radio transmitting/receiving element, within which the respective first radio transmitting/receiving element is in active coupling with a second radio transmitting/receiving element of the stator, i.e. may carry out data communication.

Based on this, the controller determines the first relative position as a projection of the second position of the second radio transmitting/receiving element of the stator, which is communicating with the respective first radio transmitting/receiving element, into the respective first position range of the first radio transmitting/receiving element communicating with the second radio transmitting/receiving element. This allows for precisely determining the first relative position and, based thereon, precisely and rapidly determining the position.

According to an embodiment, the second position information determining step comprises:
determining a magnetic field strength of at least one magnet element of the rotor based on the magnetic sensor data of the at least one magnetic sensor element of the stator via the controller in a magnetic field determining step;
determining a sensor distance along the longitudinal axis of the rotor of the magnetic sensor element to the at least one magnet element based on the determined magnetic field strength and a known reference relationship between magnetic field strength and sensor distance by the controller in a sensor distance determining step;
determining a first distance at the stator between the second radio transmitting/receiving element embodied at the second position at the stator and the previously known magnetic sensor position at the stator of the at least one magnetic sensor element by the controller in a distance-determining step;
determining a second position range at the rotor by shifting the first position range, which is arranged around the first position, by the first distance along the longitudinal axis at the rotor by the controller in a second position range determining step;
determining a magnet element position at the rotor of the at least one magnet element as the magnet element position of one of the magnet elements of the rotor that is located within the second position range or comprises the smallest distance along the longitudinal axis of the rotor to the second position range, via the controller in a magnet element position determining step;
determining the second relative position by adding the sensor distance along the longitudinal axis of the rotor between the magnetic sensor element and the at least one magnet element measured by the magnetic sensor element to the magnet element position of the at least one magnet element at the rotor by the controller in a second relative position determining step.

This may achieve the technical advantage of providing a further simplification of the position determination and, in particular, the determination of the second position information. For this purpose, magnetic field strengths of the magnet elements of the rotor are first determined by at least one magnetic sensor element of the stator. Based on the determined magnetic field strengths, the controller determines a sensor distance along the longitudinal axis of the rotor.

The sensor distance describes a distance along the longitudinal axis of the rotor between the read-out magnetic sensor element and a magnet element of the rotor. The sensor distance is determined based on a known relationship between the measured magnetic field strength and the corresponding sensor distance. The sensor distance is thus equivalent to a relative position of a projection of the read-out magnetic sensor element onto the rotor with respect to at least one of the magnet elements of the rotor.

Furthermore, the controller determines a first distance at the stator between the second position of the second radio transmitting/receiving element communicating with the first radio transmitting/receiving element and a magnetic sensor position at the stator of the read-out magnetic sensor element.

Subsequently, by mathematically shifting the first position range—positioned at the first position of the first radio transmitting/receiving element of the rotor communicating with the second radio transmitting/receiving element of the stator—by the first distance between the second position of the second radio transmitting/receiving element communicating with the first radio transmitting/receiving element and the magnetic sensor position of the read-out magnetic sensor element at the rotor, a second position range at the rotor is determined along the longitudinal axis of the rotor.

By shifting the first position range by the previously calculated distance along the longitudinal axis at the rotor, the rotor's magnet element measured by the readout magnetic sensor element is located within the second position range generated by shifting the first position range by the first distance. Alternatively, the measured magnet element is indicated by the magnet element spaced from the correspondingly generated second position range by a shortest distance.

Subsequently, a magnet element position is determined as the position of the magnet element that is located in the second position range or comprises the shortest distance to the second position range along the longitudinal axis of the rotor.

Finally, in order to determine the second relative position, the sum of the sensor distance along the longitudinal axis of the rotor between the magnetic sensor element and the magnet element measured by the magnetic sensor element is added to the magnet element position. The second relative position thus describes a position that is spaced by the sensor distance from the magnet element position of the magnet element of the rotor measured by the magnetic sensor element. The second relative position is thus located within the second position range. The described method steps allow for a simple position determination, in particular a precise determination of the second position information.

According to an embodiment, the absolute position of the rotor relative to the stator is defined as the positioning of a predefined first position marker at the rotor relative to a second position marker at the stator, wherein the absolute position determining step comprises:
determining a second distance of the second relative position at the rotor to the predefined first position marker at the rotor by the controller in a distance determining step;
determining the absolute position of the rotor relative to the stator by the controller by adding the second distance to the magnetic sensor position of the magnetic sensor element at the stator with respect to the previously known second position marker at the stator by the controller in an adding step.

This may achieve the technical advantage of enabling a further simplification of position determination. For this purpose, the absolute position of the rotor relative to the stator, or of the movable unit relative to the stationary unit, is defined as the positioning of the predefined first position marker at the rotor relative to a second position marker at the stator.

Determining the absolute position further comprises determining a second distance of the second relative position at the rotor to the predefined first position marker at the rotor. Furthermore, the absolute position is determined by adding the previously determined second distance to the magnetic sensor position of the magnetic sensor element at the stator with respect to the known second position mark. This allows for precisely determining the absolute position of the movable unit relative to the stationary unit.

According to an embodiment, the first position determining step is carried out while the movable unit is stationary.

This may achieve the technical advantage that, by determining the position of the rotor relative to the stator—or the position of the moving unit relative to the stationary unit—an initial position of the moving unit relative to the stationary unit may be determined. Based on the initial position, which is defined as an absolute position according to the definition described above, an exact position determination as the absolute position of the moving unit relative to the stationary unit may be carried out by measuring the rotor magnet elements using the magnetic sensor elements of the stator according to the principle of an incremental encoder while the moving unit is moving relative to the stationary unit.

By carrying out the method described above while the movable unit is idle relative to the stationary unit, an absolute position of the movable unit relative to the stationary unit may be determined using the information from the position-determining system in combination with the measurements of the rotor magnetic field by the magnetic sensor elements of the stator. When the moving unit is in motion relative to the stationary unit, an exact position determination of the moving unit relative to the stationary unit may be carried out based on the absolute position determined in this manner, using only measurements of the rotor magnetic fields of the rotor of the moving unit.

### Representative Configurations

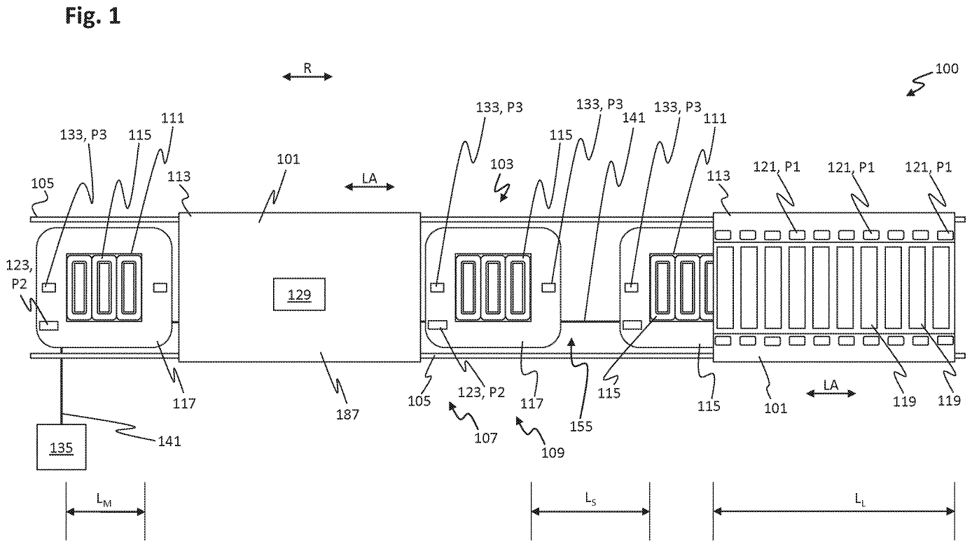

FIG. 1 shows a schematic top view of a linear transport system 100.

The linear transport system 100 comprises at least one movable unit 101, a stationary unit 103 having a guide rail 105 for guiding the at least one movable unit 101, a linear motor 107 for driving the movable unit 101 along the guide rail 105, and a position-detecting system 109.

The linear motor 107 comprises a stator 111 and at least one rotor 113. The stator 111 is embodied at the stationary unit 103, while the at least one rotor 113 is embodied at the at least one movable unit 101. The stator 111 is arranged adjacent to the guide rail 105 on the stationary unit 103 and comprises a plurality of drive coils 115 arranged in a stationary manner along the guide rail 105.

The at least one rotor 113 embodied at the at least one movable unit 101 comprises a plurality of magnet elements 119. A rotor magnetic field may be generated via the magnet elements 119 of the rotor 113. Stator magnetic fields may be generated via the energizable drive coils 115, so that a movement of the movable unit 101 along the guide rail 105 may be achieved via a magnetic coupling between the rotor magnetic field of the rotor 113 of the movable unit 101 and the stator magnetic fields of the stator 111, which may be variably generated by energizing the drive coils 115.

In the shown embodiment, the plurality of stator coils 115 of the stator 111 are grouped into a plurality of motor modules 117. The stator 111 thus comprises a plurality of motor modules 117, each of which in turn comprises a plurality of energizable drive coils 115.

FIG. 1 shows, by way of example, five motor modules 117 of the stator 111 spaced apart from one another along the guide rail 105. In the view shown in FIG. 1, a movable unit 101 is positioned above each pair of motor modules 117, in such a way that the respective motor module 117 is obscured in the view shown. A further one of the motor modules 117 is partially obscured by a movable unit 101 in FIG. 1. Each motor module 117 comprises three drive coils 115. The number of motor modules 117 and drive coils 115 shown is merely illustrative and is not intended to limit the present application. Any number of motor modules 117 may be arranged on the stationary unit 103 corresponding to the length of the stationary unit 103. The motor modules 117 may comprise a size different from that shown in FIG. 1 and a number of drive coils 115 different from the number shown.

As an example of a linear transport system 100 according to the application, FIG. 1 shows a stationary unit 103 having five motor modules 117 and two movable units 101, each comprising one rotor 113.

According to the embodiment in FIG. 1, the motor modules 117 may further comprise components such as, for example, the components of the position-detecting system 109 in addition to the drive coils 115.

In the embodiment shown, the plurality of motor modules 117 of the stator 111 are arranged on the stationary unit 103 at a distance from one another along a longitudinal axis LA of the stator 111. The plurality of motor modules 117 are each spaced apart from one another by gaps 155. In the illustrated embodiment, the motor modules 117 each have a coil length L_{M}, wherein the drive coils 115 of a motor module 117 positioned side by side each form a coil length L_{M}. The rotor 113 comprises a rotor length L_{L}. The region between the drive coils 115 of two adjacent motor modules 117 comprises a gap length L_{S}, wherein the gap 155 is embodied in this region. In the region that forms the gap length LS, additional elements of the motor modules 117 may also be arranged alongside the gap 155. The rotor length L_{L} corresponds to n times the sum of the coil length L_{M} and the gap length L_{S}.

In particular, the rotor length L_{L} may therefore be calculated by the formula:

$${L}_{L} = n ( {L}_{M} + {L}_{S} ) ,$$

where n is a natural number. The concept of n times thus also includes, in particular, that the rotor length corresponds to the sum of the coil length and the gap length.

Due to the gap 155 between the motor modules 117, motor modules 117 and, in particular, drive coils 115 may be omitted on the stationary unit 103 along the length of the guide rail 105. Along the guide rail 105, there are thus regions, particularly in the gaps 155 between the motor modules 117, in which no drive coils 115 are arranged. This allows for a more energy-efficient linear transport system 100.

The gap length L_{S} may vary in different regions of the stationary unit 103. For example, in areas of the stationary unit 103, the gap 155 may be enlarged or reduced. If required, the gap 155 may also be omitted entirely.

In sections along the guide rail 105, the ratio between the armature length L_{L}, the coil length L_{M}, and the air gap length L_{S} may vary, for example, from n=1 to n=3. This may be achieved by positioning additional motor modules 117 in the air gap 155. In particular, it is crucial for the safe drive of the movable unit 101 that a magnet element 119 of the rotor 113 is always located within the effective range of at least one coil 115 of a stator 111.

FIG. 1 also shows that the linear transport system 100 comprises a controller 135 connected to one of the motor modules 117 via a data line 141. The motor modules 117 are also interconnected via a data line 141. In particular, communication between the controller 135 and the motor modules 117 may take place via a data bus, for example a field bus, wherein the data bus may be provided via the data lines 141.

In particular, the controller 135 may be an active participant and provide the data bus, while the motor modules 117 may be passive participants that are addressed via the data bus. As the case may be, it may also be provided that each of the motor modules 117 is directly connected to the controller 135. The data lines 141 may further also provide a current and/or voltage supply to the motor modules 117. Alternatively, it is possible to use additional, unshown lines for the current and/or voltage supply.

Furthermore, the lines, in particular the data lines 141, but also other lines, may be connected to the motor modules 117 via plug-in connections. This may be achieved using appropriately embodied connectors. This allows for a connection of the motor modules 117 to a power supply or the controller 135, as well as connections between the motor modules 117. For this purpose, the motor modules 117 may each comprise, for example, two connecting elements with an input and an output element. The connecting elements may, for example, be arranged at the edge regions of the motor modules 117.

The controller 135 may be set up to issue control commands to the motor modules 117 in order to drive the motor modules 117 to energize the drive coils 115 and thereby cause the movable units 101 to move in a direction R along the guide rail 105. The controller 135 may further be set up to detect installation-related deviations in gap lengths L_{S} based on the specified movement and to take these into account when issuing further control commands.

In order to determine the position of the movable units 101 relative to the stationary unit 103, the linear transport system 100 comprises the aforementioned position-determining system 109.

According to the application, the position-detecting system 109 comprises at least a first radio transmitting/receiving element 121 embodied at the rotor 113 of the movable unit 101 and a second radio transmitting/receiving element 123 embodied at the stator 111 of the stationary unit 103. The first radio transmitting/receiving element 121 and the second radio transmitting/receiving element 123 are set up to carry out data communication with each other by exchanging identifying information Id. Each first radio transmitting/receiving element 121 and each second radio transmitting/receiving element 123 may provide its own unique identifying information Id, with the aid of which the respective first or second radio transmitting/receiving element 121, 123 may be uniquely identified. The identifying information Id may be provided by the first radio transmitting/receiving element 121 and received by a corresponding second radio transmitting/receiving element 123 of the stator 111.

Alternatively, bidirectional data communication is possible, as well, in which the respective identifying information Id is provided by the second radio transmitting/receiving element 123 and received by a corresponding first radio transmitting/receiving element 121.

In the illustrated embodiment, a plurality of first radio transmitting/receiving elements 121 are embodied at the rotors 113 of the two illustrated movable units 101. At the movable unit 101 shown on the left side of FIG. 1, the radio transmitting/receiving elements 121 are not visible because they are concealed by a cover element 187.

In the illustrated embodiment, the plurality of first radio transmitting/receiving elements 121 are arranged at the rotor 113 at a distance from one another along a longitudinal axis LA of the rotor 113. In the illustrated embodiment, the plurality of first radio transmitting/receiving elements 121 are arranged at the rotor 113 in two rows.

In the illustrated embodiment, a second radio transmitting/receiving element 123 is embodied at each motor module 117 of the stator 111. Alternatively, the second radio transmitting/receiving elements 123 may also be embodied at the stator 111 in a larger or smaller number.

According to the application, the first radio transmitting/receiving elements 121 are embodied at predetermined first positions P1 at the rotor 113. The second radio transmitting/receiving elements 123 are embodied at corresponding predetermined second positions P2 at the stator 111.

The predetermined first and second positions P1, P2 describe positions within the rotor 113 and the stator 111 and are known to the controller 135.

In order to determine the position of the movable unit 101 relative to the stationary unit 103, or of the rotor 113 relative to the stator 111, the first and second radio transmitting/receiving elements 121, 123 are set up to provide the identifying information Id to the respective other radio transmitting/receiving element 121, 123 via radio data communication.

The controller 135 may unambiguously identify the respective first and/or second radio transmitting/receiving elements 121, 123 providing the identifying information Id. Since the controller 135 knows the first and second positions P1, P2 at the rotor 113 and the stator 111, respectively, of the first and second radio transmitting/receiving elements 121, 123 that communicate via the exchange of identifying information, the controller is able to determine first position information regarding the positioning of the rotor 113 relative to the stator 111.

In this context, the first position information defines a position range in which the rotor 113 is located relative to the stator 111. The position range extends along the longitudinal axis LA of the stator 111 or the stationary unit 103 and defines a spatial range within which the rotor 113 or the movable unit 101 is located relative to the stationary unit 103.

The position range is determined exclusively based on the information from the position-determining system 109. The size of the spatial region defined by the position range along the longitudinal axis LA of the stator 111 or the stationary unit 103 is thus dependent on the resolution of the position-determining system 109. The resolution of the position-determining system 109, in turn, depends on the transmitting/receiving range of the communicating first and second radio transmitting/receiving elements 121, 123, particularly along the longitudinal axis LA. The shorter the transmitting/receiving range along the longitudinal axis LA and the denser the arrangement of the multiple first or second radio transmitting/receiving elements 121, 123 along the longitudinal axis LA, the smaller the spatial extent of the first position range is configured.

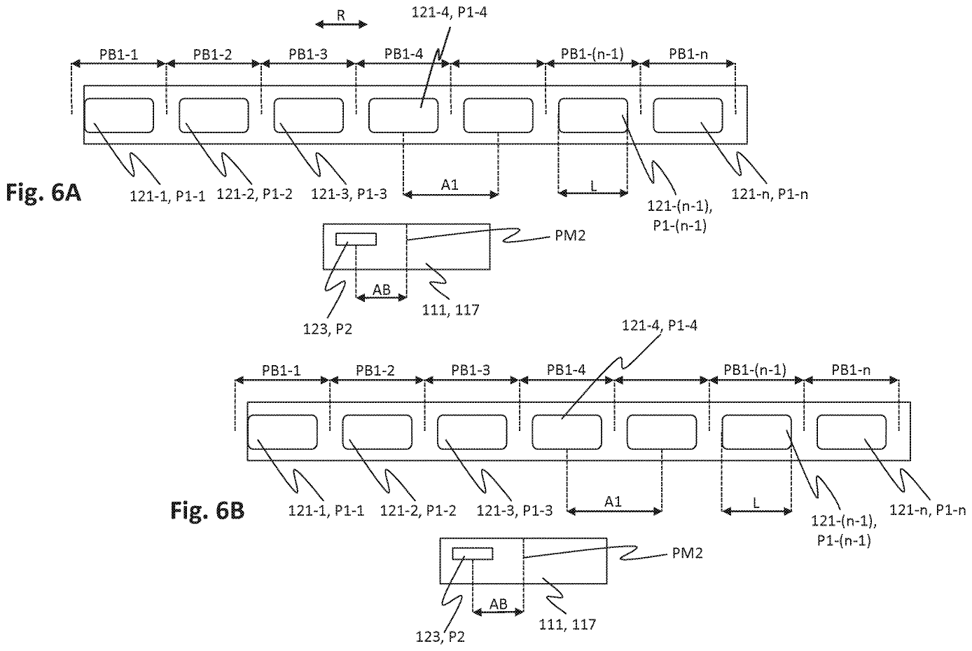

The controller 135 is thus specifically set up to carry out the method 200 of the present application for controlling a linear transport system 100. For a detailed description of the method 200 for operating a linear transport system 100, reference is made to the description accompanying FIGS. 6A and 6B to FIG. 15.

In an embodiment, the positioning system 109 is embodied as a near-field communication system. The first radio transmitting/receiving elements 121 of the mobile units 101 and the second radio transmitting/receiving elements 123 of the stationary unit 101 are accordingly embodied as near-field transmitting/receiving elements. An example of a corresponding near-field communication system is known under the technology designation RFID (radio-frequency identification). However, other near-field communication systems capable of implementing the features described in connection with the application are also included.

Data communication between the first radio transmitting/receiving elements 121 and the second radio transmitting/receiving elements 123 may then take place automatically as soon as a first radio transmitting/receiving element 121 enters the transmitting/receiving range of the respective second radio transmitting/receiving element 123.

In accordance with near-field communication or RFID technology, one of the two communicating first and second radio transmitting/receiving elements 121, 123 may be automatically radio-contacted by the respective other first and second radio transmitting/receiving elements 121, 123 and may then automatically transmit the respective identifying information Id, which may subsequently be received accordingly by the respective other first and second radio transmitting/receiving elements 121, 123.

Alternatively, the data communication between the first radio transmitting/receiving element 121 and the second radio transmitting/receiving element 123 may also be controlled by the controller 135. The controller 135 may, in this case, cause the addressed first and second radio transmitting/receiving elements 121, 123 to query and transmit the identifying information Id by sending corresponding commands to the first and second radio transmitting/receiving elements 121, 123.

As an alternative to the shown embodiment, only one first radio transmitting/receiving element 121 may be embodied at each rotor 113 of the movable units 101, while a plurality of second radio transmitting/receiving elements 123 are embodied at each motor module 117, which are arranged at the stator 111 at a distance from one another along the longitudinal direction of the stator 111. It must be ensured that the first radio transmitting/receiving element 121 at the rotor 113 may always establish an active connection with at least one second radio transmitting/receiving element 123 at the stator 111.

In the shown embodiment, an application 129 is further arranged on the movable unit 101 depicted on the left. The application 129 may be used to carry out various processes, such as loading and unloading objects to be transported onto and from the movable unit 101. In addition to a loading/unloading application, other applications 129 are possible, as well.

In the shown embodiment, magnetic sensor elements 133 are further embodied at the stator 111. In the illustrated embodiment, the magnetic sensor elements 133 are integrated into the plurality of motor modules 117. The magnetic sensor elements 133 may be used to determine the magnetic fields of the magnet elements 119 of the rotor 113 and, thereby, to determine position information of the rotor 113 relative to the stator 111 and, consequently, of the movable unit 101 relative to the stationary unit 103.

In the illustrated embodiment, the magnetic sensor elements 133 are embodied at the front and rear ends of the motor modules 117 relative to the longitudinal axis LA. As the movable unit 101 and the rotor 113 pass by the motor modules 117, the magnetic fields of the magnet elements 119 of the rotor 113 may be detected via the magnetic sensor elements 133, thereby allowing for determining the position of the rotor 113 relative to the stator 111. The magnetic sensor elements 133 may be configured as Hall sensors, in particular 2D or 3D Hall sensors.

In the shown embodiment, two magnetic sensor elements 133 are embodied in each motor module 117 at opposite ends of the motor module 117. Alternatively, more or fewer magnetic sensor elements 133 may be embodied at various locations on the motor modules 117.

The magnetic sensor elements 133 allow for determining the rotor magnetic field of the rotor 113 of the movable units 101, generated by the magnet elements 119. However, if the multiple magnet elements 119 of the rotor 113 are of identical construction and arranged in a regular pattern at the rotor 113, it is not possible to uniquely identify the magnet elements 119 solely by measuring the respective magnetic fields using the magnetic sensor elements 117.

However, by taking into account the initial position information generated by the measurements of the position-determining system 109 regarding the positioning of the rotor 113 relative to the stator 111, the magnet elements 119 of the rotor 113 may be uniquely identified based on the measurements of the magnetic fields by the magnetic sensor elements 133. For a detailed description of the position determination of the movable unit 101 relative to the stationary unit 103, reference is made to the description of the method 200 according to the application for operating a linear transport system 100 with reference to FIGS. 6A and 6B through FIG. 15.

In addition to determining the position of the movable units 101 relative to the stationary unit 103, the information from the position-determining system 109 may also be used by the controller 135 to detect deviations in the gap lengths L_{S} and to take these into account when issuing further control commands and/or to determine the gap lengths L_{S}.

Via the data communication between the first and second radio transmitting/receiving elements 121, 123, the controller 135 may determine which second radio transmitting/receiving elements 123 of which motor module 117 are in active coupling with the first radio transmitting/receiving elements 121 of the rotor 113 of the movable unit 101. By determining the distance traveled by the moving unit 101, the gap length L_{S} between adjacent motor modules 117 may be determined.

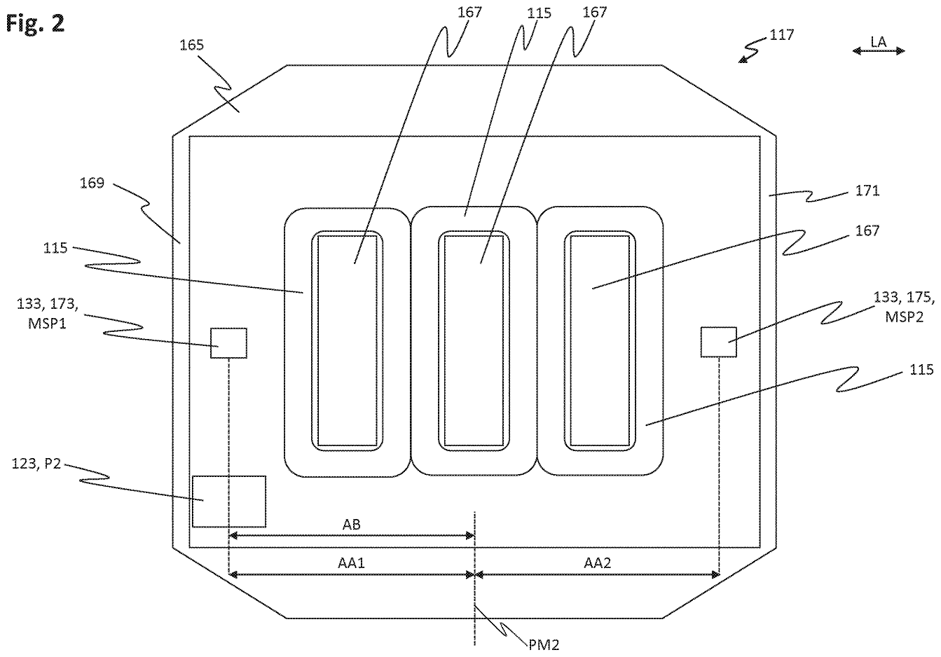

FIG. 2 shows a schematic depiction of a top view of a motor module 117 of a stator 111 of the linear transport system 100 according to an embodiment.

In the shown embodiment, the depicted motor module 117 comprises a housing 165. Drive coils 115 are positioned centrally within the housing 165. The drive coils 115 comprise coil cores 167. In the illustrated embodiment, three drive coils 115 are shown. However, the number, positioning, and configuration of the drive coils 115 may also differ from what is shown here.

Furthermore, the shown motor module 117 comprises a second radio transmitting/receiving element 123. The second radio transmitting/receiving element 123 is positioned at a predefined second position P2 within the housing 165.

In the shown embodiment, the second radio transmitting/receiving element 123 is embodied as a near-field communication (NFC) transmitting/receiving element or an RFID transmitting/receiving element.

Alternatively, the positioning and/or size and/or shape of the second radio transmitting/receiving element 123 may differ from the embodiment shown in FIG. 2.

In the shown embodiment, two magnetic sensor elements 133 are further embodied at the illustrated motor module 117. The two magnetic sensor elements 133 are embodied at two opposite ends of the motor module 117 relative to the longitudinal axis LA and are arranged at the same height as the drive coils 115 of the motor module 117. A first magnetic sensor element 173 is embodied at a first end 169 of the motor module 117, and a second magnetic sensor element 175 is embodied at a second end 171 of the motor module 117.

Alternatively, a different number of magnetic sensor elements 133 may be embodied at the motor module 117, which are arranged at other locations on the motor module 117.

In the shown embodiment, the two magnetic sensor elements 133 are arranged at designated magnetic sensor positions MSP1, MSP2 on the motor module 117. The first magnetic sensor element 173 is arranged at a first magnetic sensor position MSP1, and the second magnetic sensor element 175 is arranged at a second magnetic sensor position MSP2. The first and second magnetic sensor positions MSP1, MSP2 are known to the controller 135. The first and second magnetic sensor positions MSP1, MSP2, as well as the second position P2 of the second radio transmitting/receiving element 123, may be defined relative to a second position marker PM2 of the motor module 117 or the stator 111, respectively. The second position marker PM2 represents a defined location of the shown motor module 117 or the stator 111 that is known to the controller 135.

In the shown embodiment, the first and second magnetic sensor positions MSP1, MSP2 are defined by first and second magnetic sensor element distances AA1, AA2, wherein the first magnetic sensor element distance AA1 describes a distance between the first magnetic sensor position MSP1 and the second position marker PM2, and wherein the second magnetic sensor element distance AA2 describes a distance between the second magnetic sensor position MSP2 and the second position marker PM2.

Furthermore, the second position P2 of the second radio transmitting/receiving element 123 is defined by a second radio transmitting/receiving element distance AB relative to the second position marker PM2.

In the shown embodiment, the second position marker PM2 is positioned centrally with respect to the longitudinal axis LA on the motor module 117. Alternatively, however, the second position marker PM2 may also be defined at a different location on the motor module 117.

The shown motor module 117 may further comprise an end protection plate which protects the drive coils 115 and the other shown elements from contamination and damage.

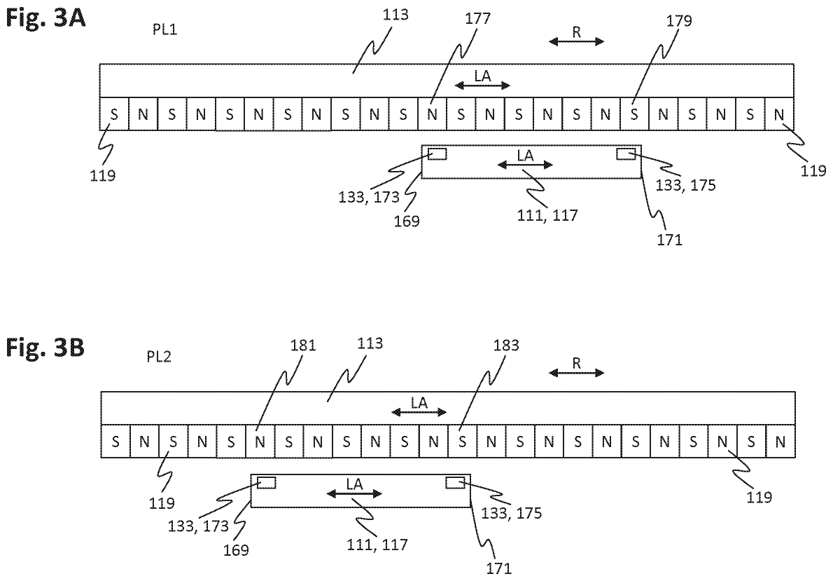

FIG. 3A and FIG. 3B show schematic depictions of the positioning of a rotor 113 relative to the stator 111 of the linear transport system 100 according to an embodiment.

FIGS. 3A and 3B shows two positions of the rotor 113 relative to the stator 111 schematically depicted in FIGS. 3A and 3B. In the illustration shown, only a single motor module 117 of the stator 111 is depicted. For the sake of simplicity, the stator 111 and the rotor 113 are shown only schematically in the FIGS. 3A and 3B. The rotor 113 comprises a plurality of magnet elements 119. The magnet elements 119 are shown alternately with a magnetic south pole orientation S and a magnetic north pole orientation N.

To simplify the depiction, the magnet elements 119 of the rotor 113 are shown directly adjacent to one another along the longitudinal axis LA. Alternatively, gaps may be embodied between the magnet elements 119.

Furthermore, the magnet elements 119 may be arranged in a configuration different from the arrangement shown in FIGS. 3A and 3B, in which the magnet elements 119 are arranged alternately with opposite magnetic pole directions. For example, the magnet elements 119 may be arranged in a Hallbach configuration at the rotor 113.

At the stator 111, analogous to the embodiment in FIG. 2, the two magnetic sensor elements 133 are embodied at the two opposite ends 169, 171, wherein the first magnetic sensor element 173 is embodied at the first end 169 and the second magnetic sensor element 175 is embodied at the opposite second end 171.

Between FIG. 3A and FIG. 3B, the rotor 113 is moved along the direction of motion R relative to the stator 111. In the FIG. 3A, the rotor 113 is positioned relative to the stator 111 in a first rotor position PL1. In FIG. 3B, the rotor 113 is positioned relative to the stator 111 in a second rotor position PL2.

FIGS. 3A and 3B illustrate that, based solely on the magnetic field measurements of the magnetic fields of the magnet elements 119 of the rotor 113 by the magnetic sensor elements 133 of the stator 111, it is not possible to unambiguously determine the position of the rotor 113 relative to the stator 111.

In FIG. 3A, the rotor 113 is positioned in the first rotor position PL1. In this context, the first magnetic sensor element 173 measures the magnetic field of a first magnet element 177, and the second magnetic sensor element 175 measures the magnetic field of a second magnet element 179. The first and second magnet elements 177, 179 are arranged opposite to the first and second magnetic sensor elements 173, 175, respectively, in the first rotor position PL1 of the rotor 113 relative to the stator 111. In this context, the first magnet element 177 comprises a magnetic north pole direction N, while the second magnet element 179 has a magnetic south pole direction S.

In FIG. 3B, the rotor 113 is positioned in the second rotor position PL2 relative to the stator 111. In the second rotor position PL2, the first magnetic sensor element 173 measures the magnetic field of a third magnet element 181, and the second magnetic sensor element 175 measures the magnetic field of a fourth magnet element 183. The third magnet element 181 also comprises a magnetic north pole direction N, while the fourth magnet element 183 also comprises a magnetic south pole direction S.

Since the magnet elements 119 of the rotor 113 are each embodied to be identical to one another, the first magnet element 177 and the third magnet element 181, as well as the second magnet element 179 and the fourth magnet element 183, each exhibit identical magnetic fields in pairs. Based on the measurements of the magnetic sensor elements 133, the first rotor position PL1 of the rotor 113 relative to the stator 111 is therefore indistinguishable from the second rotor position PL2. Thus, based solely on position determination by measuring the magnetic fields of the magnet elements 119 of the rotor, no unambiguous position determination of the rotor 113 relative to the stator 111 may be achieved.

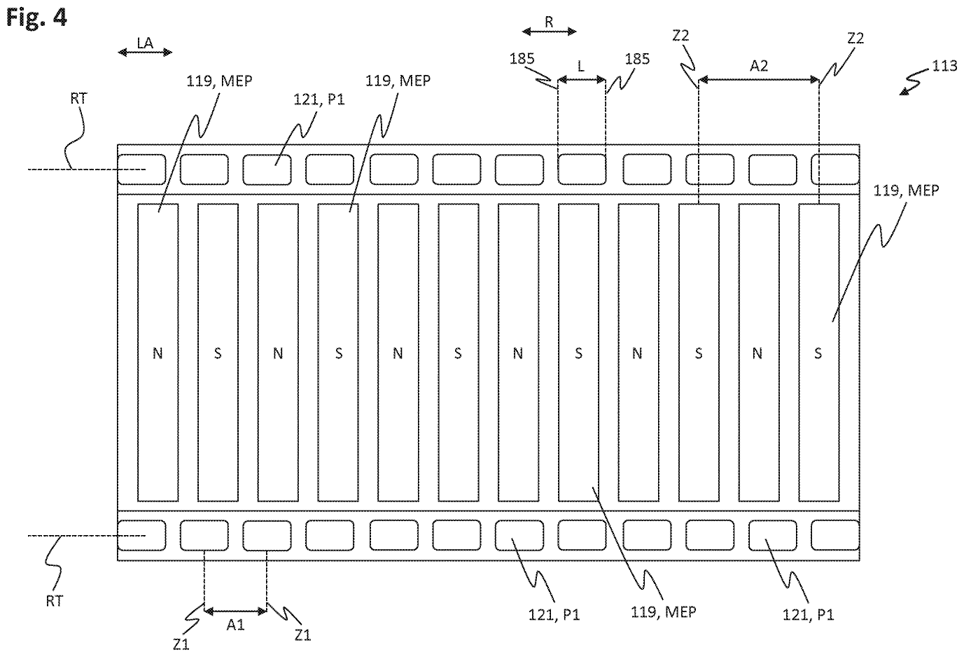

FIG. 4 shows a schematic depiction of a rotor 113 of the linear transport system 100 according to an embodiment.

In FIG. 4, for clarity reasons, the rotor 113 is only shown in a schematic manner. Of the rotor 113, only the magnet elements 119 and the first radio transmitting/receiving elements 121 of the position-determining system 109 are shown.

The shown embodiment of the rotor 113 corresponds to the embodiment in FIG. 1. Analogously to FIG. 1, the rotor 113 comprises a plurality of first radio transmitting/receiving elements 121, which are arranged at the rotor 113 at intervals along the longitudinal axis LA. Each first radio transmitting/receiving element 121 is arranged at an individual first position P1 at the rotor 113. Furthermore, each first radio transmitting/receiving element 121 comprises individual identifying information Id. Each first radio transmitting/receiving element 121 may be uniquely identified via the individual identifying information Id. In the controller 135, the corresponding first position P1 is recorded for each of the first radio transmitting/receiving elements 121 in conjunction with the individual identifying information Id, so that an individual first position P1 may be assigned to each first radio transmitting/receiving element 121.

According to an embodiment, at least one of the first radio transmitting/receiving elements 121, or a plurality or all of the first radio transmitting/receiving elements 121, may additionally be set up to provide an identification identifier. With the aid of the identification identifier, the respective rotor 113 or the movable unit 101 may be uniquely identified. The identifying information Id and/or the identification code may be read by the second radio transmitting/receiving element 123 embodied at the stator 111.

In the case of multiple movable units 101 and, consequently, multiple rotors 113, the identification identifiers provided by the first radio transmitting/receiving elements 121 of the various rotors 113 are different, thereby allowing for unambiguously identifying the various rotors 113 or movable units 101 based on the identification identifiers. However, the identifying information Id provided by the first radio transmitting/receiving elements 121 of the different rotors 113 may be the same for the first radio transmitting/receiving elements 121 of a plurality of different rotors 113 or mobile units 101 if the respective first radio transmitting/receiving element/receiving elements 121 in the different rotors 113 are positioned at the same first positions P1.

In the illustrated embodiment, the multiple first radio transmitting/receiving elements 121 are arranged side-by-side in two rows RT along the longitudinal axis LA. The two rows RT are spaced apart from one another, and the magnet elements 119 of the rotor 113 are positioned in a gap between the two rows RT. The magnet elements 119 are arranged at the rotor 113 at magnet element positions MEP known to the controller 135.

The identifying information Id provided by the first radio transmitting/receiving elements 121 of the two rows RT is configured in such a way that unique identification of the first radio transmitting/receiving elements 121 is allowed for.

Analogously to the embodiment in FIGS. 3A and 3B, the magnet elements 119 are arranged along the direction of movement R alternately with opposite magnetic pole directions S, N.

In the shown embodiment, the first radio transmitting/receiving elements 121 are arranged side by side in the rows RT in such a way that a mean distance A1 between two immediately adjacent first radio transmitting/receiving elements 121 is smaller than a minimum mean distance A2 between two magnet elements 119 having the same magnetic pole direction S or N.

In the shown embodiment, the distance A1 between two adjacent first radio transmitting/receiving elements 121 is defined between two centers Z1 of the adjacent first radio transmitting/receiving elements 121. The distance A2 between two magnet elements 119 comprising the same magnetic pole direction S or N is defined between two centers Z2 of the magnet elements 119.

In the shown embodiment, the first radio transmitting/receiving elements 121 are further configured in such a way that a dimension L of a first radio transmitting/receiving element 121 along the longitudinal axis LA is smaller than the smallest distance A2 between two magnet elements 119 comprising the same magnetic pole direction S or N.

The variable L along the longitudinal axis LA of the first radio transmitting/receiving elements 121 is defined between two outer edges 185 of the first radio transmitting/receiving elements 121.

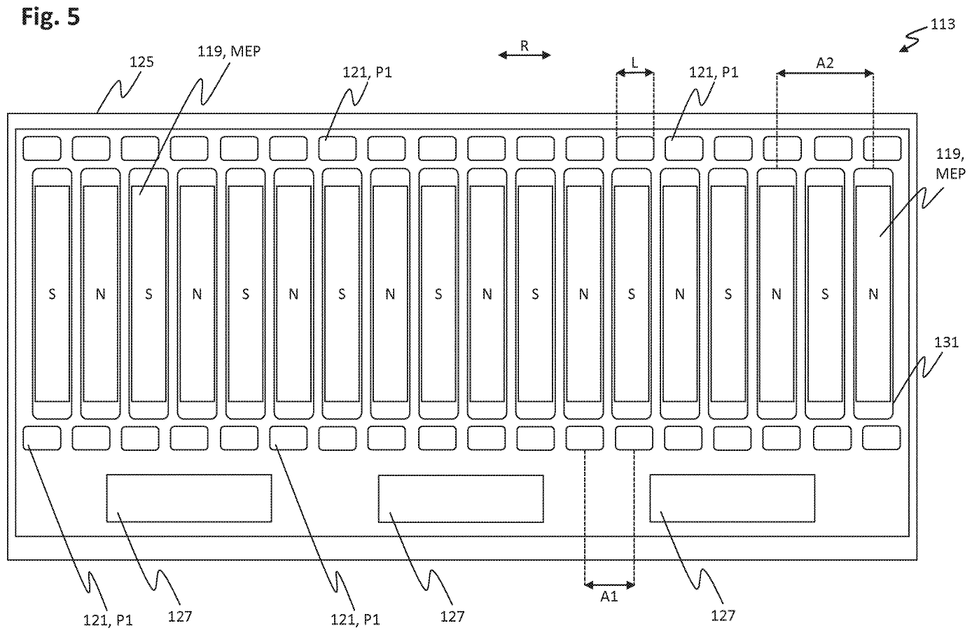

FIG. 5 shows a further schematic depiction of a rotor 113 of the linear transport system 100 according to a further embodiment.

The embodiment of the carrier 113 shown in FIG. 5 is based on the embodiment in FIG. 4 and includes all features described therein. Insofar as these remain unchanged, a detailed description is omitted.

In the embodiment shown, the magnet elements 119 and the first radio transmitting/receiving elements 121 are jointly arranged on a printed circuit board 125. The arrangement of the magnet elements 119 and the first radio transmitting/receiving elements 121 further corresponds to the arrangement in the embodiment according to FIG. 4.

In addition to the magnet elements 119 and the first radio transmitting/receiving elements 121, further functional modules 127 are embodied in or on the printed circuit board 125. In FIG. 5, three different functional modules 127 are shown as examples. The functional modules 127 may, for example, serve as a control module for energy transfer between the mobile unit 101 and the stationary unit 103, and/or as a control module for controlling an application 129 on the movable unit 101 and/or as a control module for controlling data communication between the movable unit 101 and the stationary unit 103 and/or as a functional module for a different function of the movable unit 101.

In the shown embodiment, an energy-transmitting coil 131 for energy transmission between the mobile unit 101 and the stationary unit 103 is further embodied at the printed circuit board 125. The energy-transmitting coil 131 is arranged around the magnet elements 119.

FIG. 6A and FIG. 6B show schematic depictions of the position-detecting system 109 according to an embodiment.

FIG. 6A and FIG. 6B show two schematic depictions of the rotor 113 relative to the stator 111. In the depiction shown, only a single motor module 117 of the stator 111 is depicted. On the motor module 117 of the stator 111, a second radio transmitting/receiving element 123 is arranged at the second position P2, in accordance with the embodiment shown in FIG. 2. For the sake of simplicity in FIGS. 6A and 6B, the drive coils 115 of the motor module 117 are shown in FIGS. 1 and 2.

The rotor 113 of the movable unit 101 is also shown only in simplified form. In FIGS. 6A and 6B, primarily only the plurality of first radio transmitting/receiving elements 121 arranged along the longitudinal axis LA according to the embodiments of FIGS. 4 and 5 are shown. The radio transmitting/receiving elements 121 are arranged at the rotor 113 at first positions P1 along the longitudinal axis LA, spaced apart from one another by a distance A1.

In the shown embodiment, the rotor 113 comprises a plurality of n first radio transmitting/receiving elements 121, each of which is embodied at different first positions P1 along the longitudinal axis LA at the rotor 113.

For example, a first radio transmitting/receiving element 121-1 shown on the far left of the illustration is arranged at a first position P1-1. A second first radio transmitting/receiving element 121-2 is accordingly arranged at a second first position P1-2. A third first radio transmitting/receiving element 121-3 is arranged at a third first position P1-3 at the rotor. A fourth first radio transmitting/receiving element 121-4 is arranged at a fourth first position P1-4 at the rotor 113. An (n−1)-th first radio transmitting/receiving element 121-(n−1) is arranged at an (n−1)-th first position P1-(n−1) at the rotor 113. An nth first radio transmitting/receiving element 121-n is positioned at an nth first position P1-n at the rotor 113.

The n first radio transmitting/receiving elements 121-1 to 121-n each have first position ranges PB1-1 to PB1-n. The first first radio transmitting/receiving element 121-1 comprises a first first position range PB1-1. The second first radio transmitting/receiving element 121-2 comprises a second first position range PB1-2. The third first radio transmitting/receiving element 121-3 comprises a third first position range PB1-3. The fourth first radio transmitting/receiving element 121-4 comprises a fourth first position range PB1-4. The (n−1)-th first radio transmitting/receiving element 121-(n−1) comprises an (n−1)-th first position region PB1-(n−1). The n-th first radio transmitting/receiving element 121-n has an n-th first position region PB1-n.

The n first position ranges PB1-1 through PB1-n each describe the spatial regions in which the second radio transmitting/receiving element 123 of the stator 111 may be in effective coupling with the respective first radio transmitting/receiving element 121-1 to 121-n, thereby enabling data communication between the second radio transmitting/receiving element 123 the respective first radio transmitting/receiving element 121-1 to 121-n may take place. The corresponding first position ranges PB1-1 to PB1-n extend along the longitudinal axis LA.

The respective first position ranges PB1-1 through PB1-n may have different dimensions for the various first radio transmitting/receiving elements 121-1 through 121-n, or, as in the illustrated embodiment, they may be of equal size. The sizes of the first position areas PB1-1 to PB1-n depend primarily on the transmitting/receiving range of the respective first radio transmitting/receiving elements 121-1 to 121-n or the respective second radio transmitting/receiving element 123.

Preferably, identical first radio transmitting/receiving elements 121-1 to 121-n are installed in the rotor 113, so that the first position ranges PB1-1 to PB1-n have correspondingly identical spatial dimensions.

FIGS. 6A and 6B now show two different positions of the rotor 113 relative to the motor module 117 of the stator 111. In the first positioning shown in FIG. 6A, the second radio transmitting/receiving element 123 of the stator 111 is arranged, with respect to the longitudinal axis LA, between the third first radio transmitting/receiving element 121-3 and the fourth first radio transmitting/receiving element 121-4.

The second radio transmitting/receiving element 123 is thus, with respect to the longitudinal axis LA, neither completely within the third first position range PB1-3 of the third first radio transmitting/receiving element 121-3 nor completely within the fourth first position range PB1-4 of the fourth first radio transmitting/receiving element 121-4. Since the second radio transmitting/receiving element 123 of the stator 111 is thus not completely located within any of the first position ranges PB1-1 to PB1-n of the first radio transmitting/receiving elements 121-1 through 121-n, there may be various solutions regarding the effective coupling of the second radio transmitting/receiving element 123 with the first radio transmitting/receiving elements 121-1 to 121-n of the rotor 113.

According to an alternative, the first radio transmitting/receiving elements 121-1 to 121-n and the second radio transmitting/receiving element 123 may be configured in such a way that, when the second radio transmitting/receiving element 123 is positioned relative to the first radio transmitting/receiving elements 121-1 to 121-n of the rotor 113, data communication of the second radio transmitting/receiving element 123 may take place both with the third first radio transmitting/receiving element 121-3 and with the fourth first radio transmitting/receiving element 121-4. Alternatively, data communication may also take place with an even larger number of first radio transmitting/receiving elements 121-1 to 121-n.

In the configuration shown in FIG. 6A, the second radio transmitting/receiving element 123 may thus, as the case may be, receive both the identifying information Id of the third first radio transmitting/receiving element 121-3 and the identifying information Id of the fourth first radio transmitting/receiving element 121-4. The respective identifying information Id of the various first radio transmitting/receiving elements 121-1 to 121-n is configured in such a way that the first radio transmitting/receiving elements 121-1 to 121-n providing the respective identifying information Id may be uniquely identified based on the respective identifying information Id.

According to another alternative embodiment, the positioning system 109 may also be configured in such a way that, when the rotor 113 is positioned as shown in FIG. 6A, the second radio transmitting/receiving element 123 always establishes an active coupling with only one of the first radio transmitting/receiving elements 121-1 to 121-n.

The selection of the first radio transmit/receiving element 121-1 to 121-n, which may establish active coupling with the second radio transmitting/receiving element 123, may, for example, depend on which first radio transmitting/receiving element 121-1 to 121-n responds more quickly to a request from the second radio transmitting/receiving element 123. If, in the example shown in FIG. 6A, in response to a request to establish communication and thus to establish an active connection from the second radio transmitting/receiving element 123, the third first radio transmitting/receiving element 121-3 responds faster than the fourth first radio transmitting/receiving element 121-4, then an active coupling is established between the second radio transmitting/receiving element 123 and the third first radio transmitting/receiving element 121-3, and thus the identifying information Id of the third first radio transmitting/receiving element 121-3 is received by the second radio transmitting/receiving element 123.

The selection of the first radio transmitting/receiving element 121-1 to 121-n, which establishes an active coupling with the second radio transmitting/receiving element 123, may alternatively depend, for example, on which first radio transmitting/receiving element 121-1 to 121-n has a stronger influence on the radiation pattern of the second radio transmitting/receiving element 123. Depending on the position and due to corresponding component tolerances, each first radio transmitting/receiving element 121-1 to 121-n will influence the transmission field of the second radio transmitting/receiving element 123 in a slightly different manner. The strength of this influence may serve as a selection criterion for establishing an active connection.

If, in the example shown in FIG. 6A, in response to a request to establish communication and thus to establish effective coupling on the part of the second radio transmitting/receiving element 123, the third first radio transmitting/receiving element 121-3 influences the transmission field of the second radio transmitting/receiving element 123 more strongly than the fourth first radio transmitting/receiving element 121-4, then an active coupling is established between the second radio transmitting/receiving element 123 and the third first radio transmitting/receiving element 121-3, and thus the identifying information Id of the third first radio transmitting/receiving element 121-3 is received by the second radio transmitting/receiving element 123.

The range in which, according to the preceding description, the second radio transmitting/receiving element 123 establishes an active coupling with more than one first radio transmitting/receiving element 121-1 through 121-n and/or a system-dependent selection is made as to which first radio transmitting/receiving element 121-1 to 121-n the second radio transmitting/receiving element 123 establishes effective coupling is generally very small, so that effective coupling is usually always established directly as described below in accordance with FIG. 6B.

In the second positioning of the rotor 113 relative to the motor module 117 of the stator 111 in FIG. 6B, however, the second radio transmitting/receiving element 123 of the rotor 113 is completely and exclusively located within the third first position range PB1-3 of the third first radio transmitting/receiving element 121-3. In the arrangement shown, an effective coupling is thus achieved, in accordance with the application, between the second radio transmitting/receiving element 123 of the stator 111 and the third first radio transmitting/receiving element 121-3, so that data communication and an exchange of the corresponding identifying information Id may take place between the second radio transmitting/receiving element 123 and the third first radio transmitting/receiving element 121-3.

The data communication between the second radio transmitting/receiving element 123 and the n first radio transmitting/receiving elements 121-1 to 121-n may occur automatically, as soon as the second radio transmitting/receiving element 123 of the stator 111 is positioned relative to the longitudinal axis LA within at least one of the first position ranges PB1-1 to PB1-n of the respective first radio transmitting/receiving elements 121-1 to 121-n.

Alternatively, the data communication may also be controlled by the controller 135 of the linear transport system 100. As soon as the second radio transmitting/receiving element 123 of the stator 111 is positioned, with respect to the longitudinal axis LA, completely or at least partially within at least one of the first position ranges PB1-1 to PB1-n of at least one of the first radio transmitting/receiving elements 121-1 to 121-n, the controller 135 issues corresponding commands to the second radio transmitting/receiving element 123 of the stator 111 and/or to the respective first radio transmitting/receiving element 121-1 to 121-n to transmit the respective identifying information Id.

Alternatively, the data communication may also be controlled by the controller 135 of the linear transport system 100. For example, after the linear transport system 100 is started up, it is not clear to the controller 135 where the individual movable units 101 or rotors 113 are located. The controller 135 then issues corresponding commands to the second radio transmitting/receiving element 123 of the stator 111 and/or to the respective first radio transmitting/receiving elements 121-1 through 121-n to transmit the respective identifying information Id.

According to the application, the identifying information Id may be transmitted by both the first radio transmitting/receiving elements 121-1 to 121-n and the second radio transmitting/receiving element 123, and may be received by the respective other radio transmitting/receiving elements 121-1 to 121-n, 123, and forwarded to the controller 135 for further evaluation.

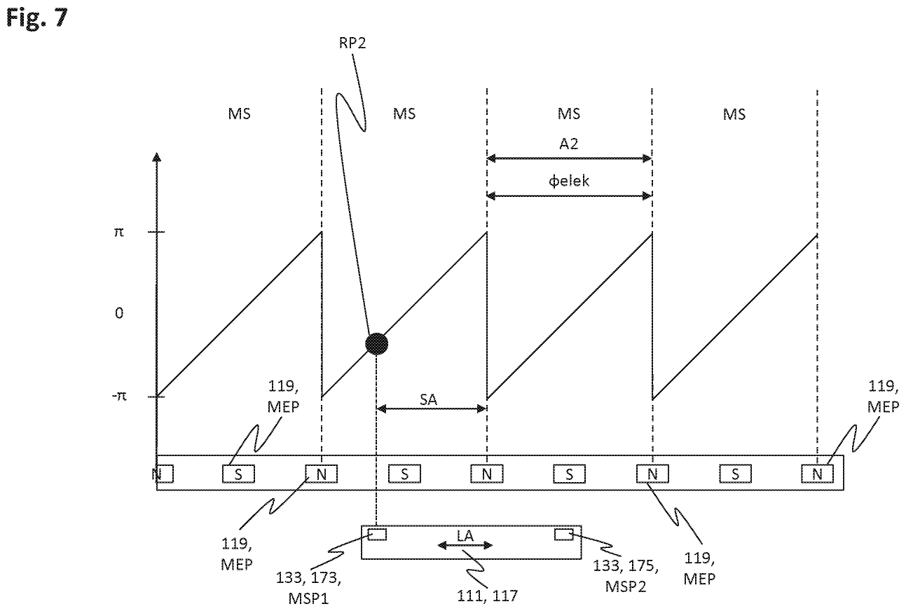

FIG. 7 shows a graphical depiction of a magnetic field measurement of the magnetic fields of the magnet elements 119 of the rotor 113.

Similar to FIGS. 6A and 6B, the arrangement of the rotor 113 of the movable unit relative to the stator 111 of the stationary unit 103 is again shown in a highly simplified manner in FIG. 7.

Of the stator 111 of the stationary unit 103, merely a motor module 117 is shown. Of the motor module 117, the drive coils 115 are again shown in FIGS. 1 and 2 for the sake of simplicity, analogous to FIGS. 6A and 6B. Furthermore, the motor module 117 includes two magnetic sensor elements 133, in the form of the first and second magnetic sensor elements 173, 175, which are arranged at the first magnetic sensor positions MSP1 and MSP2 on the motor module 117.

Furthermore, a plurality of magnet elements 119 are shown at the rotor 113. The magnet elements 119 are arranged at various magnet element positions MEP at the rotor 113. In the shown embodiment, the individual magnet elements 119 are each arranged alternately with opposite magnetic pole directions S or N. Alternatively, a different arrangement of the magnet elements 119, for example a Halbach arrangement, may be implemented.

In the shown embodiment, the magnet elements 119 are grouped into magnet sectors MS. In this case, three magnet elements form one magnet sector MS.

The grouping of the magnet elements 119 into the magnet sectors MS shown is primarily intended to illustrate the method of the application. However, the method of the application may also be carried out without the use of the magnet sectors MS.

In the shown embodiment, any two magnet elements 119 with the same magnetic pole direction S or N are spaced apart by a distance A2. The distance A2 defines the dimensions of the magnet sectors MS along the longitudinal axis LA. The distances A2 between two adjacent magnet elements 119 with the same magnetic pole direction S or N correspond to an electrical angle φₑₗ of 360°.

The solid line with a sawtooth profile illustrates the progression of the electrical angle φₑₗ along the longitudinal axis LA from −Π to +Π.

The following describes, with reference to FIG. 7, individual steps for measuring the rotor magnetic field of the magnet elements 119 using the at least one magnetic sensor element 133 of the stator 111.

Due to the arrangement of the magnet elements 119 having alternating magnetic pole directions along the longitudinal axis LA, the rotor magnetic field of the rotor 113 exhibits a periodic pattern along the longitudinal axis LA. Due to this periodic variation, measuring the rotor magnetic field using the at least one magnetic sensor element 133 of the stator 111 allows for the precise positioning of the magnetic sensor element 133 relative to the directly adjacent magnet elements 119 of the rotor 113 within a magnet sector MS. The rotor magnetic field is embodied to be periodic in such a way that within the magnet sectors MS, the rotor magnetic field exhibits a non-constant and non-periodic profile, thereby allowing for precise position determination. However, the profiles of the rotor magnetic fields are identical in the various magnet sectors MS, so that an absolute position of the rotor 113 relative to the stator 111 of the linear transport system 100 cannot be determined solely by measuring the rotor magnetic field.

Consequently, by measuring the rotor magnetic field using the magnetic sensor elements 133 of the stator 111, it is not possible to unambiguously determine which magnet elements 119 of which magnet sector MS were measured by the magnetic sensor element 133 in the measurement carried out. However, by knowing the profile of the rotor magnetic field along the longitudinal axis LA, the controller 135 may, based on the measurements of the at least one magnetic sensor element 133, position the at least one magnetic sensor element 133 relative to the longitudinal axis LA within an unspecified magnet sector MS.

In the example shown, the rotor 113 is positioned relative to the stator 111 in such a way that a projection of the first magnetic sensor position MSP1 of the depicted first magnetic sensor element 173 onto the rotor 113 is located within a depicted magnet sector MS. This position is indicated by the point between two adjacent magnet elements 119 having the same magnetic pole direction. Due to the known, non-constant, and non-periodic variation of the rotor magnetic field within the individual magnet sectors MS, the exact positioning of the projection of the first magnetic sensor position MSP1 onto the rotor 113 within a magnet sector MS may be determined based on the measurements of the magnetic field of the first magnetic sensor element 173. This positioning is referred to below as the second relative position RP2. The second relative position RP2 describes a relative positioning of the first magnetic sensor element 173 with respect to the magnet elements 119 of a sector.

The second relative position RP2, previously described as the projection of the first magnetic sensor position MSP1 of the first magnetic sensor element 173 onto the rotor 113, is hereinafter calculated as a sensor distance SA of the first magnetic sensor element 173 to at least one magnet element 119. In order to determine the second relative position RP2 via the controller 135, the controller has access to a relationship between the detected magnetic field strength and a distance to at least one of the magnet elements 119 within the individual magnet sectors MS.

In the diagram shown, the sensor distance SA is defined relative to a right-hand magnet element 119 of an unspecified magnet sector MS. Alternatively, the sensor distance SA may also be defined relative to the left-hand magnet element 119 or the central magnet element 119 of the unspecified magnet sector MS.

The sensor distance SA may, for example, be defined as the shortest distance to one of the magnet elements 119 having a predetermined magnetic pole direction S or N. The sensor distance SA may further be defined as the shortest distance to such a magnet element 119 in a predefined direction along the longitudinal axis LA.

Since the magnetic profiles of the rotor magnetic field along the longitudinal axis LA are identical in the various magnet sectors MS, the relative positioning of the projection of the magnetic sensor position MSP1 of the respective magnetic sensor element 133 onto the rotor 113 may be determined for each of the multiple magnet sectors MS based on the aforementioned relationship between the magnetic field strength detected by the magnetic sensor element 133 and the sensor distance SA to at least one of the magnet elements 119 within a magnet sector MS.

Based solely on the magnetic field measurements of the magnetic sensor elements 133 of the stator 111, a precise second relative position RP2 may thus be determined, which describes a projection of the respective magnetic sensor position MSP1, MSP2 of the respective magnetic sensor element 133 onto the rotor 113. However, as described previously, due to the periodic nature of the rotor magnetic field, the magnetic field measurements of the rotor magnetic field by the magnetic sensor elements 133 do not allow for the unambiguous determination of which of the magnet sectors MS of the rotor 113 the determined second relative position RP2 is located in.

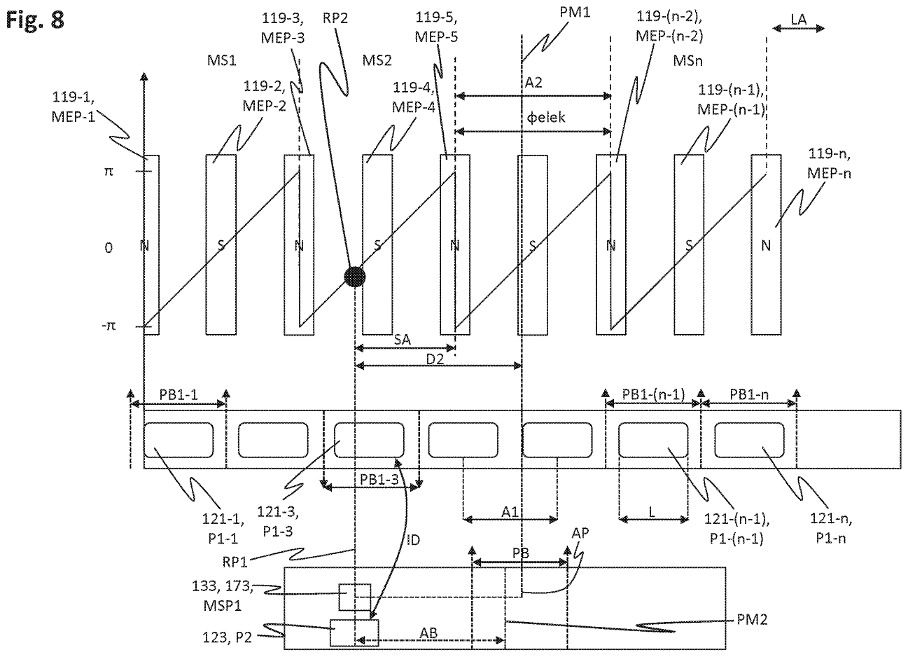

FIG. 8 shows a graphical depiction of an absolute position determination according to a first embodiment.

Analogously to FIGS. 6A and 6B, the arrangement of the rotor 113 of the movable unit relative to the stator 111 of the stationary unit 103 is again shown in a highly simplified manner in FIG. 8.

Again, only a motor module 117 is shown of the stator 111 of the stationary unit 103. Again, analogously to FIGS. 6A and 6B, the drive coils 115 of the motor module 117 are shown in FIGS. 1 and 2 for the sake of simplicity. Instead, the motor module 117 includes a second radio transmitting/receiving element 123, which is embodied at the second position P2 at the stator 111. Furthermore, the motor module 117 includes a magnetic sensor element 133, in the form of the first magnetic sensor element 173, which is arranged at the first magnetic sensor position MSP1 on the motor module 117.

Analogously to FIGS. 6A and 6B, the rotor 113 is shown to include a plurality of first radio transmitting/receiving elements 121-1 through 121-n, which are arranged at the respective first positions P1-1 through P1-n at the rotor 113 and define the respective first position ranges PB1-1 through PB1-n.

Furthermore, n different magnet elements 119 are shown at the rotor 113. The magnet elements 119 are arranged at different magnet element positions MEP at the rotor 113.

A first magnet element 119-1 is arranged at a first magnet element position MEP-1. A second magnet element 119-2 is arranged at a second magnet element position MEP-2. A third magnet element 119-3 is positioned at a third magnet element position MEP-3 at the rotor 113. A fourth magnet element 119-4 is arranged at a fourth magnet element position MEP-4. A fifth magnet element 119-5 is positioned at a fifth magnet element position MEP-5 at the rotor. An (n−2)-th magnet element 119-(n−2) is positioned at an (n−2)-th magnet element position MEP-(n−2). An (n−1)-th magnet element 119-(n−1) is positioned at an (n−1)-th magnet element position MEP-(n−1). An n-th magnet element 119-n is positioned at an n-th magnet element position MEP-n at the rotor 113.

In the illustrated embodiment, the n different magnet elements 119-1 to 119-n are each arranged alternately with opposite magnetic pole directions. Thus, the first magnet element 119-1, the third magnet element 119-3, the fifth magnet element 119-5, the (n−2)-th magnet element 119-(n−2), and the n-th magnet element 119-n are each arranged with a magnetic north pole direction N. The second magnet element 119-2, the fourth magnet element 119-4, and the (n−1)-th magnet element 119-(n−1), on the other hand, are arranged with a magnetic south pole orientation S.

Alternatively, a different arrangement of the magnet elements 119-1 to 119-n, such as a Halbach arrangement, may be implemented.

In the embodiment shown, adjacent magnet elements 119-1 to 119-n are grouped into magnet sectors MS1, MS2, and MSn. The first magnet element 119-1, the second magnet element 119-2, and the third magnet element 119-3 form a first magnet sector MS1. The third magnet element 119-3, the fourth magnet element 119-4, and the fifth magnet element 119-5 further form a second magnet sector MS2. The (n−2)-th magnet element 119-(n−2), the (n−1)-th magnet element 119-(n−1), and the n-th magnet element 119-n, on the other hand, form an n-th magnet sector MSn.

The grouping of the magnet elements 119-1 to 119-n to form the shown magnet sectors MS, MS2, MSn serves primarily to illustrate the method of the application. However, the method of the application may also be carried out without the use of the magnet sectors MS1, MS2, MSn.

In the shown embodiment, the adjacent magnet elements 119-1 to 119-n with the same magnetic pole direction S or N are spaced apart by a distance A2. The distance A2 hereby defines the dimensions of the magnet sectors MS1, MS2, MSn along the longitudinal axis LA. The distances A2 between magnet elements 119-1 to 119-n with the same magnetic pole direction S or N correspond to an electrical angle φₑₗ of 360°.

The continuous line with a sawtooth profile shows the progression of the electrical angle φₑₗ along the longitudinal axis LA.

In the following, individual steps of the method according to the application for operating a linear transport system 100 are described with reference to FIG. 8.

In order to determine the position of the movable unit 101 relative to the stationary unit 103, initial position information from the position-determining system 109 is first provided. This initial position information defines a position range PB within which the positioning of the movable unit relative to the stationary unit 103, or of the rotor 113 relative to the stator 111, may be restricted. In order to provide the position information via the position-determining system 100, data communication is first established between at least one second radio transmitting/receiving element 123 of the stator 111 and at least one first radio transmitting/receiving element 121-1 through 121-n.

As already described with reference to FIGS. 6A and 6B, data communication takes place between the at least one first radio transmitting/receiving element 121-1 to 121-n of the rotor 113 and the at least one second radio transmitting/receiving element 123 of the stator 111, provided that the at least one first radio transmitting/receiving element 121-1 to 121-n and the at least one second radio transmitting/receiving element 123 of the stator 111 are in effective coupling with one another. The effective coupling between the at least one first radio transmitting/receiving element 121-1 to 121-n of the rotor 113 and the at least one second radio transmitting/receiving element 123 of the stator 111 may occur when the at least one second radio transmitting/receiving element 123 is arranged, with respect to the longitudinal axis LA, within the first position range PB-1 to PB1-n of the respective first radio transmitting/receiving element 121-1 to 121-n.

FIG. 8 illustrates such a case. The at least one second radio transmitting/receiving element 123 of the stator 111 is arranged in the third first position range PB1-3 of the third first radio transmitting/receiving element 121-3. Due to the active coupling between the second radio transmitting/receiving element 123 of the stator 111 and the third first radio transmitting/receiving element 121-3, identifying information Id is provided between the radio transmitting/receiving elements 121-3, 123 that are in active coupling. The identifying information Id may be transmitted from the third first radio transmitting/receiving element 121-3 to the second radio transmitting/receiving element 123 and received by the latter. Alternatively, data transmission may occur in the opposite direction, i.e. the second radio transmitting/receiving element 123 provides the corresponding identifying information Id to the third first radio transmitting/receiving element 121-3.

The direction of data communication is of secondary importance for position determination. The primary effect of the data communication between the at least one second radio transmitting/receiving element 123 of the stator 111 and the first radio transmitting/receiving element/receiving elements 121-1 to 121-n for position determination is the precise determinability of the respective radio transmitting/receiving elements 121-1 to 121-n, 123 that are communicating with one another. This is allowed for by the respective identifying information Id exchanged.

Based on the provided identifying information Id, which is forwarded to the controller 135 of the linear transport system 100 following data transmission between the third first radio transmitting/receiving element 121-3 and the second radio transmitting/receiving element 123, the third radio transmitting/receiving element 121-3 and the second radio transmitting/receiving element 123, which are in data communication with each other, may be uniquely identified.

Based on the unique identification of the two radio transmitting/receiving elements, the controller 135 may determine the respective positions at the rotor 113 or at the stator 111. The controller 135 is aware of the individual positions of the first radio transmitting/receiving elements 121-1 to 121-n at the rotor 113 and of the second radio transmitting/receiving elements 123 at the stator 111. Based on the unique identification of the first and second radio transmitting/receiving elements 121-3, 123 communicating with each other, and based on the read identifying information Id, the controller 135 determines the third first position P1-3 as the position of the third first radio transmitting/receiving element 121-3 engaged in data communication and the second position P2 at the stator 111 of the second radio transmitting/receiving element 123 at the stator 111 acting as the counterpart in the data communication.

The controller 135 is further aware of the first position ranges PB1-1 to PB1-n of the first radio transmitting/receiving elements 121-1 to 121-n as the position ranges in which a corresponding second radio transmitting/receiving element 123 of the stator 111 is positioned with respect to the longitudinal axis LA, thereby allowing for data communication between the second radio transmitting/receiving element 123 of the stator 111 and the respective first radio transmitting/receiving elements 121-1 to 121-n of the rotor 113.

The controller 135 thus determines, in the embodiment shown in FIG. 8, that the second radio transmitting/receiving element 123 of the stator 111 is arranged relative to the longitudinal axis LA within the third first position range PB1-3 of the third first radio transmitting/receiving element 121-3 of the rotor 113. This means that a projection of the second position P2 of the second radio transmitting/receiving element 123 at the stator 111 onto the rotor 113 is located within the third first position range PB1-3 of the third first radio transmitting/receiving element 121-3.

Position determination of the rotor 113 relative to the stator 111 is carried out, according to an embodiment, by taking into account a first position marker PM1 at the rotor 113 relative to a second position marker PM2 at the stator 111. The first and second position markers PM1, PM2 represent defined positions at the rotor 113 and the stator 111, respectively. By using the relative positioning of the first and second position markers PM1, PM2 with respect to one another, a unique positioning of the extended rotor 113 relative to the extended stator 111 may be achieved.

In order to determine the position range PB, the controller 135 now shifts a projection of the third position range PB1-3 onto the stator 111 by the second radio transmitting/receiving element distance AB in the direction of the second position marker PM2. The second radio transmitting/receiving element distance AB represents the distance between the second position P2 of the second radio transmitting/receiving element 123 at the stator 111 and the second position marker PM2 at the stator 111. The position range PB is generated by shifting the projection of the third first position range PB1-3 along the longitudinal axis LA toward the second position marker PM2.

As shown in FIG. 8, the position range PB is arranged around the second position marker PM2 at the stator 111 and comprises the dimensions of the third first position range PB1-3 of the third first radio transmitting/receiving element 121-3. The position range PB thus describes a spatial region in which the first and second position marks PM1, PM2 of the rotor 113 and the stator 111, respectively, are arranged relative to one another. Based on the first position information from the position-determining system 109, which was determined exclusively from the information of the first and second radio transmitting/receiving elements 121-1 through 121-n, 123, a spatial region may thus be defined in which the rotor 113 is positioned relative to the stator 111 or the movable unit 101 relative to the stationary unit 103. The accuracy of the position determination based on this thus depends on the size of the first position ranges PB1-1 to PB1-n of the first radio transmitting/receiving elements 121-1 to 121-n.

In order to further refine the position determination based on the first position information from the position-determining system 109, a second position information is taken into account, considering measurements of the rotor magnetic field of the magnet elements 119-1 to 119-n of the rotor 113 by the at least one magnetic sensor element 133 of the stator 111, as described with reference to FIG. 7.

Furthermore, the controller 135 defines a first relative position RP1. The first relative position RP1 is determined based on the measurements from the position-detecting system 109. In the example shown, the first relative position RP1, which represents a relative positioning of the at least one second radio transmitting/receiving element 123 of the stator 111 with respect to the first radio transmitting/receiving elements 121-1 through 121-n of the rotor 113, by the third position range PB1-3 of the third first radio transmitting/receiving element 121-3, which is in effective coupling with the second radio transmitting/receiving element 123.

In order to resolve the ambiguity of the magnetic field measurements of the rotor magnetic field by the magnetic sensor elements 133, the information from the position-determining system 109 is subsequently taken into account.

For this purpose, a second set of position information is determined. This second set of position information comprises information from the magnetic field measurements by the magnetic sensor elements 133, in particular the second relative position RP2, and further takes into account the information from the position-determining system 109, in particular the first relative position RP1.

Since the controller 135 knows both the first positions P1-1 to P1-n of the first radio transmitting/receiving elements 121-1 to 121-n and the magnet element positions MEP-1 to MEP-n of the magnet elements 119-1 to 119-n of the rotor 113, the position-determining system 109 may identify, by determining the third first position range PB1-3, the respective magnet sector MS1, MS2, MSn in which the relative position RP2 is located. As an alternative or in addition, the respective magnet element 119-1 to 119-n, relative to which the second relative position RP2, i.e. the projection of the magnetic sensor position MSP1 of the magnetic sensor element 133 providing the sensor data of the rotor magnetic field 173 at the rotor 113 by the sensor distance SA is arranged at a distance, may be identified as the magnet element 119-1 to 119-n that is either positioned within the third first position range PB1-3 or has the smallest distance to said third first position range PB-3.

In this way, the respective magnet sector MS1, MS2, MSn may be identified by determining the second relative position RP2, or the respective magnet element 119-1 to 119-n may be identified, provided that the projection of the magnetic sensor position MSP1 of the respective magnet element 133, 173 has the sensor distance SA.

After identifying the respective magnet sector MS1, MS2, MSn or the respective magnet element 119-1 to 119-n, from which the projection of the magnetic sensor position MSP1 is spaced apart by the sensor distance SA, a unique position at the rotor 113 may be assigned to the second relative position RP2. Subsequently, a second distance D2 is calculated. The second distance D2 refers to a distance at the rotor 113 between the second relative position RP2, determined as described above, and the first position marker PM1 at the rotor 113.

In order to determine an absolute position of the rotor 113 relative to the stator 111, the second distance D2 between the second relative position RP2 and the first position marker PM1 is subsequently added, along the longitudinal axis LA, to the first magnetic sensor position MSP1 of the first magnetic sensor element 173 at the stator 111. The result of the addition yields the absolute position AP of the rotor 113 relative to the stator 111 and describes the positioning of a projection of the first position marker PM1 of the rotor 113 onto the stator 111 relative to the second position marker PM2 of the stator 111.

By taking into account the first and second position information from the position-determining system 109 and the measurements from the magnetic sensor elements 133, respectively, the method described above may thus determine an absolute position AP of the rotor 113 relative to the stator 111, or of the movable unit 101 relative to the stationary unit 103.

FIG. 8 shows merely an example of a possible positioning of the rotor 113 relative to the stator 111, or relative to a motor module 117 of the stator 111. The number, size, and arrangement of the shown first and second radio transmitting/receiving elements 121-1 to 121-n, 123, as well as the magnet elements 119-1 to 119-n and magnetic sensor elements 133, and the first position ranges PB1-1 to PB1-n and the magnet sectors MS1, MS2, MSn, as well as the selection of the first and second radio transmitting/receiving elements 121-1 to 121-n, 123 that are in effective coupling with one another, and the arrangement of the second relative position RP2, are merely exemplary and are not intended to limit the present application.

The rotor 113 and the stator 111, or the movable unit 101 and the stationary unit 103, are each provided with a position scale characteristic of the rotor 113 or the movable unit 101 and the stator 111 or the stationary unit 103. The position scales of the movable unit 101 or the rotor 113 and the stationary unit 103 or the stator 111 each extend along the longitudinal axis LA of the rotor 113 or of the stator 111, respectively, and serve to determine the absolute positions of the elements at the rotor 113 and at the stator 111, respectively, and to determine the absolute position of the movable unit 101 relative to the stationary unit 103 and of the rotor 113 relative to the stator 111, respectively.

The first positions P1 and the first position ranges PB1 of the first radio transmitting/receiving elements 121, as well as the first position marker PM1 at the rotor 113, are assigned numerical values with respect to the position scale characteristic of the rotor 113. The same applies to the second position P2 of the second radio transmitting/receiving element 123, as well as the magnetic sensor position MSP of the at least one magnetic sensor element 133 and the second position marker PM2, which are similarly assigned numerical values relative to the position scale characteristic of the stator 111 or the respective motor module 117, or are located on the position scale.

The sensor distance SA of the projection of the magnetic sensor position MSP of the magnetic sensor element 133, which captures the magnetic sensor data of the rotor magnetic field, onto the rotor 113, however, cannot be assigned a numerical value for absolute positioning with respect to the characteristic position scale of the rotor 113. The sensor distance SA, on the other hand, merely describes a relative distance of the projection of the magnetic sensor position MSP to a magnet element 119 of the rotor 113. The actual magnet element position MEP of the magnet element 119 is not necessary for determining the sensor distance SA. The sensor distance SA is determined exclusively based on the relationship between magnetic field strength and sensor distance SA, which is known to the controller 135.

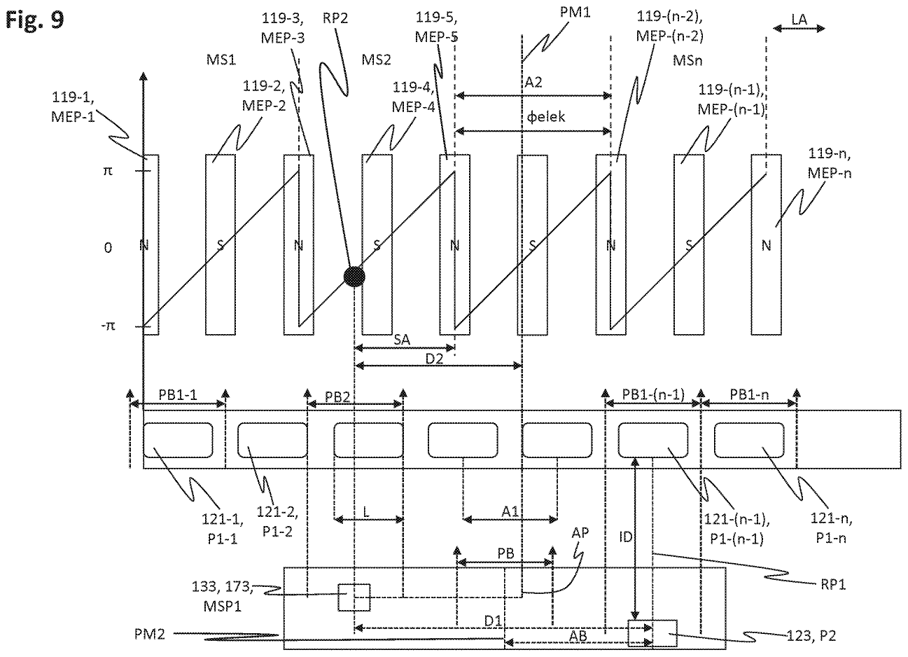

FIG. 9 shows a graphical depiction of an absolute position determination according to a second embodiment.

Analogously to FIGS. 6A and 6B, the arrangement of the rotor 113 of the movable unit relative to the stator 111 of the stationary unit 103 is again shown in a highly simplified manner in FIG. 9.

Of the stator 111 of the stationary unit 103, only a motor module 117 is shown. Again, analogously to FIGS. 6A and 6B, the drive coils 115 of the motor module 117 are shown in FIGS. 1 and 2 for the sake of simplicity. Instead, the motor module 117 includes a second radio transmitting/receiving element 123, which is embodied at the second position P2 at the stator 111. Furthermore, the motor module 117 includes a magnetic sensor element 133, in the form of the first magnetic sensor element 173, which is arranged at the first magnetic sensor position MSP1 on the motor module 117.

Analogously to FIGS. 6A and 6B, the rotor 113 is shown to include a plurality of first radio transmitting/receiving elements 121-1 through 121-n, which are arranged at the respective first positions P1-1 through P1-n at the rotor 113 and define the respective first position ranges PB1-1 through PB1-n.

Furthermore, n different magnet elements 119 are shown at the rotor 113. The magnet elements 119 are arranged at different magnet element positions MEP at the rotor 113.

A first magnet element 119-1 is arranged at a first magnet element position MEP-1. A second magnet element 119-2 is arranged at a second magnet element position MEP-2. A third magnet element 119-3 is positioned at a third magnet element position MEP-3 at the rotor 113. A fourth magnet element 119-4 is arranged at a fourth magnet element position MEP-4. A fifth magnet element 119-5 is positioned at a fifth magnet element position MEP-5 at the rotor. An (n−2)-th magnet element 119-(n−2) is positioned at an (n−2)-th magnet element position MEP-(n−2). An (n−1)-th magnet element 119-(n−1) is positioned at an (n−1)-th magnet element position MEP-(n−1). An n-th magnet element 119-n is positioned at an n-th magnet element position MEP-n at the rotor 113.

In the shown embodiment, the n different magnet elements 119-1 to 119-n are each arranged alternately with opposite magnetic pole directions. Thus, the first magnet element 119-1, the third magnet element 119-3, the fifth magnet element 119-5, the (n−2)-th magnet element 119-(n−2), and the n-th magnet element 119-n are each arranged with a magnetic north pole direction N. The second magnet element 119-2, the fourth magnet element 119-4, and the (n−1)-th magnet element 119-(n−1), on the other hand, are arranged with a magnetic south pole orientation S.

Alternatively, a different arrangement of the magnet elements 119-1 to 119-n, such as a Halbach arrangement, may be implemented.

In the shown embodiment, the respective adjacent magnet elements 119-1 to 119-n are grouped into magnet sectors MS1, MS2, MSn. The first magnet element 119-1, the second magnet element 119-2, and the third magnet element 119-3 form a first magnet sector MS1. The third magnet element 119-3, the fourth magnet element 119-4, and the fifth magnet element 119-5 further form a second magnet sector MS2. The (n−2)-th magnet element 119-(n−2), the (n−1)-th magnet element 119-(n−1), and the n-th magnet element 119-n, on the other hand, form an n-th magnet sector MSn.

The grouping of the magnet elements 119-1 to 119-n into the shown magnet sectors MS, MS2, and MSn serves primarily to illustrate the method of the application. However, the method of the application may also be carried out without the use of the magnet sectors MS1, MS2, and MSn.

In the embodiment shown, the adjacent magnet elements 119-1 through 119-n, which have the same magnetic pole orientation (S or N), are spaced apart by a distance A2. The distance A2 hereby defines the dimensions of the magnet sectors MS1, MS2, MSn along the longitudinal axis LA. The distances A2 between adjacent magnet elements 119-1 to 119-n having the same magnetic pole direction S or N correspond to an electrical angle φₑₗ of 360°.

The continuous line with a sawtooth profile illustrates the progression of the electrical angle φₑₗ along the longitudinal axis LA.

In the following, individual steps of the method according to the application for operating a linear transport system 100 are described with reference to FIG. 9.

In order to determine the position of the movable unit 101 relative to the stationary unit 103, an initial position information from the position-determining system 109 is first provided. This initial position information defines a position range PB within which the positioning of the movable unit relative to the stationary unit 103, or of the rotor 113 relative to the stator 111, may be restricted. In order to provide the position information via the position-determining system 100, data communication is first established between at least one second radio transmitting/receiving element 123 of the stator 111 and at least one first radio transmitting/receiving element 121-1 to 121-n.

As already described with reference to FIGS. 6A and 6B, data communication takes place between the at least one first radio transmitting/receiving element 121-1 to 121-n of the rotor 113 and the at least one second radio transmitting/receiving element 123 of the stator 111, provided that the at least one first radio transmitting/receiving element 121-1 to 121-n and the at least one second radio transmitting/receiving element 123 of the stator 111 are in effective coupling with one another.

The effective coupling between the at least one first radio transmitting/receiving element 121-1 to 121-n of the rotor 113 and the at least one second radio transmitting/receiving element 123 of the stator 111 may occur when the at least one second radio transmitting/receiving element 123 is arranged relative to the longitudinal axis LA within the first position range PB-1 to PB-n of the respective first radio transmitting/receiving element 121-1 to 121-n.

Such a case is depicted in the shown FIG. 9. The at least one second radio transmitting/receiving element 123 of the stator 111 is arranged in the (n−1)-th first position range PB1-(n−1) of the (n−1)-th first radio transmitting/receiving element 121-(n−1). Due to the active coupling between the second radio transmitting/receiving element 123 of the stator 111 and the (n−1)-th first radio transmitting/receiving element 121-(n−1), identifying information Id is provided between the radio transmitting/receiving elements 121-(n−1) and 123. The identifying information Id may be transmitted from the (n−1)-th first radio transmitting/receiving element 121-(n−1) to the second radio transmitting/receiving element 123 and received by the latter. As an alternative, data transmission may occur in the opposite direction, i.e. the second radio transmitting/receiving element 123 provides the (n−1)-th first radio transmitting/receiving element 121-(n−1) with the corresponding identifying information Id.

The direction of data communication is of secondary importance for position determination. The primary effect of the data communication between the at least one second radio transmitting/receiving element 123 of the stator 111 and the first radio transmit/receiving elements 121-1 to 121-n for position determination is the precise determinability of the respective radio transmitting/receiving elements 121-1 to 121-n, 123 communicating with one another. This is ensured by the respective identifying information Id exchanged.

Based on the provided identifying information Id, which is forwarded to the controller 135 of the linear transport system 100 following data transmission between the (n−1)-th first radio transmitting/receiving element 121-(n−1) and the second radio transmitting/receiving element 123, the (n−1)-th radio transmitting/receiving element 121-(n−1) and the second radio transmitting/receiving element 123, which are in data communication with each other, may be uniquely identified.

Based on the unique identification of the two radio transmitting/receiving elements, the controller 135 may determine their respective positions at the rotor 113 and the stator 111, respectively. The controller 135 is aware of the individual positions of the first radio transmitting/receiving elements 121-1 through 121-n at the rotor 113 and of the second radio transmitting/receiving elements 123 at the stator 111. Based on the unique identification of the first and second radio transmitting/receiving elements 121-(n−1), 123 communicating with each other, and based on the read identifying information Id, the controller 135 determines the (n−1)-th first position P1-(n−1) as the position of the (n−1)-th first radio transmitting/receiving element 121-(n−1) and the second position P2 at the stator 111 of the second radio transmitting/receiving element 123 at the stator 111 acting as the counterpart in the data communication.

The controller 135 is further aware of the first position ranges PB1-1 to PB1-n of the first radio transmitting/receiving elements 121-1 to 121-n as the position ranges in which a corresponding second radio transmitting/receiving element 123 of the stator 111 must be positioned with respect to the longitudinal axis LA, so that data communication may take place between the second radio transmitting/receiving element 123 of the stator 111 and the respective first radio transmitting/receiving elements 121-1 to 121-n of the rotor 113.

The controller 135 thus determines, in the embodiment shown in FIG. 9, that the second radio transmitting/receiving element 123 of the stator 111 must be positioned, with respect to the longitudinal axis LA, in the (n−1)-th first position range PB1-(n−1) of the (n−1)-th first radio-transmitting/receiving element 121-(n−1) of the rotor 113. This means that a projection of the second position P2 of the second radio transmitting/receiving element 123 at the stator 111 onto the rotor 113 is located in the (n−1)-th first position region PB1-(n−1) of the (n−1)-th first radio transmitting/receiving element 121-(n−1).

Position determination of the rotor 113 relative to the stator 111 is carried out, according to an embodiment, by taking into account a first position marker PM1 at the rotor 113 relative to a second position marker PM2 at the stator 111. The first and second position markers PM1, PM2 represent predetermined positions at the rotor 113 and the stator 111, respectively. By using the relative positioning of the first and second position markers PM1, PM2 with respect to one another, a unique positioning of the extended rotor 113 relative to the extended stator 111 may be achieved.

In order to determine the position range PB, the controller 135 now shifts a projection of the (n−1)-th first position range PB1-(n−1) onto the stator 111 by the second radio transmitting/receiving element spacing AB in the direction of the second position marker PM2. The second radio transmitting/receiving element spacing AB represents the distance between the second position P2 of the second radio transmitting/receiving element 123 at the stator 111 and the second position marker PM2 at the stator 111. The position range PB is generated by shifting the projection of the (n−1)-th first position range PB1-(n−1) along the longitudinal axis LA toward the second position marker PM2.

As shown in FIG. 9, the position range PB is arranged around the second position marker PM2 at the stator 111 and comprises the dimensions of the (n−1)-th first position range PB1-(n−1) of the (n−1)-th first radio transmitting/receiving element 121-(n−1). The position region PB thus describes a spatial region in which the first and second position markers PM1, PM2 of the rotor 113 and the stator 111, respectively, are arranged relative to one another. Based on the first position information from the position-determining system 109, which was determined exclusively from the information of the first and second radio transmitting/receiving elements 121-1 through 121-n, 123, a spatial region may thus be defined in which the rotor 113 is positioned relative to the stator 111 or the movable unit 101 relative to the stationary unit 103. The accuracy of the position determination based on this thus depends on the size of the first position ranges PB1-1 to PB1-n of the first radio transmitting/receiving elements 121-1 to 121-n.

In order to further refine the position determination based on the first position information from the position-determining system 109, a second position information is taken into account, considering measurements of the rotor magnetic field of the magnet elements 119-1 to 119-n of the rotor 113 by the at least one magnetic sensor element 133 of the stator 111, as described with reference to FIG. 7. In order to avoid repetition, a detailed description is omitted here, and reference is made to the explanations regarding FIG. 7.

Furthermore, a first relative position RP1 is defined by the controller 135. The first relative position RP1 is determined based on the measurements of the position-determining system 109. In the example shown, the first relative position RP1, which represents a relative positioning of the at least one second radio transmitting/receiving element 123 of the stator 111 with respect to the first radio transmitting/receiving elements 121-1 to 121-n of the rotor 113, is defined by the (n−1)-th position range PB1-(n−1) of the (n−1)-th first radio transmitting/receiving element 121-(n−1) that is in active coupling with the second radio transmitting/receiving element 123.

The second relative position RP2, previously described as an imaginary projection of the first magnetic sensor position MSP1 of the first magnetic sensor element 173 onto the rotor 113, is calculated below as a sensor distance SA of the first magnetic sensor element 173 to at least one of the magnet elements 119-1 to 119-n. In order to determine the second relative position RP2 by the controller 135, the controller has at its disposal a relationship between the detected magnetic field strength and a distance to at least one of the magnet elements 119-1 to 119-n within the individual magnet sectors MS1, MS2, MSn.

In the diagram shown, the sensor distance SA is defined relative to the fifth magnet element 119-5 of the second magnet sector MS2. As an alternative thereto, the sensor distance SA may also be defined relative to the third magnet element 119-3 or the fourth magnet element 119-4 of the second magnet sector MS2.

The sensor distance SA may, for example, be defined as the shortest distance to one of the magnet elements 119-1 to 119-n having a predetermined magnetic pole direction S or N. The sensor distance SA may further be defined as the shortest distance to such a magnet element 119-1 to 119-n in a predefined direction along the longitudinal axis LA.

Since the magnetic field progressions of the rotor magnetic field along the longitudinal axis LA are identical in the various magnet sectors MS1, MS2, MSn, the aforementioned relationship between the magnetic field strength detected by the magnetic sensor element 133 and the sensor distance SA to at least one of the magnet elements 119-1 to 119-n within a magnet sector MS1, MS2, MSn, a relative positioning of the projection of the magnetic sensor position MSP1 of the respective magnetic sensor element 133 onto the rotor 113 may be determined for each of the multiple magnet sectors MS1, MS2, MSn.

Based solely on the magnetic field measurements of the magnetic sensor elements 133 of the stator 111, a precise second relative position RP2 may thus be determined, which describes a projection of the respective magnetic sensor position MSP1, MSP2 of the respective magnetic sensor element 133 onto the rotor 113. However, as described previously, due to the periodic nature of the rotor magnetic field, the magnetic field measurements of the rotor magnetic field by the magnetic sensor elements 133 do not allow for unambiguous determination of which of the magnet sectors MS1, MS2, MSn of the rotor 113 the determined second relative position RP2 is located in.

In order to resolve this ambiguity in the magnetic field measurements of the rotor magnetic field by the magnetic sensor elements 133, the information from the position-determining system 109 is subsequently taken into account.

For this purpose, a second position information is determined. The second position information comprises information from the magnetic field measurements by the magnetic sensor elements 133, in particular the second relative position RP2, and further takes into account the information from the position-determining system 109, in particular the first relative position RP1.

In order to determine the second position information, which in particular defines in which of the magnet sectors MS1, MS2, MSn the previously determined second relative position RP2 is located, or in which the magnet element 119-1 to 119-n is identified, relative to from which the second relative position RP2 is spaced by the sensor distance SA, a first distance D1 is first determined at the stator 111.

The first distance D1 defines a distance between the second position P2 of the second radio transmitting/receiving element 123 and the magnetic sensor position MSP1, MSP2 of the respective magnetic sensor element 133 at the stator 111. The first distance D1 is known here based on the manufacturing dimensions of the stator 111 or the respective motor module 117 of the controller 135.

In order to identify the magnet sector MS1, MS2, MSn in which the second relative position RP2 is located, or to identify the respective magnet element 119-1 to 119-n to which the projection of the magnetic sensor position MSP1, MSP2 of the respective magnetic sensor element 133 onto the rotor 113 is spaced by the sensor distance SA, a second position range PB2 is subsequently calculated via the controller 135. The second position range PB2 is determined by shifting the previously determined first position range PB1-1 to PB1-n of the respective first radio transmitting/receiving element 121-1 to 121-n, which is in active coupling and data communication with the second radio transmitting/receiving element 123, by the first distance D1 along the longitudinal axis LA at the rotor 113.

In the example shown, the second position range PB2 is thus calculated by shifting the previously determined (n−1)-th first position range PB1-(n−1) of the (n−1)-th first radio transmitting/receiving element 123 of the stator 111, which is in data communication with the second radio transmitting/receiving element 123 of the stator 111, (n−1)-th first radio transmitting/receiving element 121-(n−1), by the first distance D1 between the second position P2 of the second radio transmitting/receiving element 123 and the first magnetic sensor position MSP1 of the first magnetic sensor element 173 at the stator 111 along the longitudinal axis LA at the rotor 113.

Since the controller 135 knows both the first positions P1-1 to P1-n of the first radio transmitting/receiving elements 121-1 to 121-n and the magnet element positions MEP-1 to MEP-n of the magnet elements 119-1 to 119-n of the rotor 113, the respective magnet sector MS1, MS2, MSn may be identified by calculating the second position range PB2, in which the second position range PB2 calculated in this manner is located. As an alternative or in addition, the respective magnet element 119-1 to 119-n, from which the second relative position RP2, i.e. the projection of the magnetic sensor position MSP1 of the magnetic sensor element 133 providing the sensor data of the rotor magnetic field onto the rotor 113 is arranged at a distance by the sensor distance SA, may be identified as the magnet element 119-1 to 119-n may be identified as the magnet element 119-1 to 119-n that is either positioned within the second position range PB2 or has the smallest distance to said second position range PB2.

In this way, the respective magnet sector MS1, MS2, MSn may be identified by the arrangement of the second relative position RP2, or the respective magnet element 119-1 to 119-n may be identified, provided that the projection of the magnetic sensor position MSP1 of the respective magnet element 133 has the sensor distance SA.

After identifying the respective magnet sector MS1, MS2, MSn or the respective magnet element 119-1 to 119-n, from which the projection of the magnetic sensor position MSP1 is spaced apart by the sensor distance SA, a unique position at the rotor 113 may be assigned to the second relative position RP2. Subsequently, a second distance D2 is calculated. The second distance D2 refers to a distance at the rotor 113 between the second relative position RP2, determined as described above, and the first position marker PM1 at the rotor 113.

In order to determine an absolute position of the rotor 113 relative to the stator 111, the second distance D2 between the second relative position RP2 and the first position marker PM1 is then added, along the longitudinal axis LA, to the first magnetic sensor position MSP1 of the first magnetic sensor element 173 at the stator 111. The result of the addition yields the absolute position AP of the rotor 113 relative to the stator 111 and describes the positioning of a projection of the first position marker PM1 of the rotor 113 onto the stator 111 relative to the second position marker PM2 of the stator 111.

By taking into account the first and second position information from the position-determining system 109 and the measurements from the magnetic sensor elements 133, respectively, the method described above may thus determine an absolute position AP of the rotor 113 relative to the stator 111, or of the movable unit 101 relative to the stationary unit 103.

FIG. 9 shows only an example of a possible positioning of the rotor 113 relative to the stator 111, or relative to a motor module 117 of the stator 111. The number, size and arrangement of the shown first and second radio transmitting/receiving elements 121-1 through 121-n, 123, as well as the magnet elements 119-1 to 119-n and magnetic sensor elements 133, and the first position ranges PB1-1 to PB1-n and the magnet sectors MS1, MS2, MSn, as well as the selection of the first and second radio transmitting/receiving elements 121-1 to 121-n, 123 that are in effective coupling with one another, and the arrangement of the second relative position RP2, are merely exemplary and are not intended to limit the present application.

The rotor 113 and the stator 111, or the movable unit 101 and the stationary unit 103, are each provided with a position scale characteristic of the rotor 113 or the movable unit 101 and the stator 111 or the stationary unit 103. The position scales of the movable unit 101 or the rotor 113 and the stationary unit 103 or the stator 111 run along the longitudinal axis LA of the rotor 113 or the stator 111, respectively, and serve to determine the absolute positions of the elements at the rotor 113 and at the stator 111, respectively, and to determine the absolute position of the movable unit 101 relative to the stationary unit 103 and of the rotor 113 relative to the stator 111, respectively.

The first positions P1 and the first position ranges PB1 of the first radio transmitting/receiving element 121, as well as the first position marker PM1 at the rotor 113, are assigned numerical values with respect to the position scale characteristic of the rotor 113. The same applies to the second position P2 of the second radio transmitting/receiving element 123, as well as the magnetic sensor position MSP of the at least one magnetic sensor element 133 and the second position marker PM2, which are similarly assigned numerical values relative to the position scale characteristic of the stator 111 or the respective motor module 117, or are located on the position scale.

The sensor distance SA of the projection of the magnetic sensor position MSP of the magnetic sensor element 133, which captures the magnetic sensor data of the rotor magnetic field, onto the rotor 113, however, cannot be assigned a numerical value for absolute positioning with respect to the characteristic position scale of the rotor 113. The sensor distance SA, on the other hand, merely describes a relative distance of the projection of the magnetic sensor position MSP to a magnet element 119 of the rotor 113. The actual magnet element position MEP of the magnet element 119 is not necessary for determining the sensor distance SA. The sensor distance SA is determined exclusively based on the relationship between magnetic field strength and sensor distance SA, which is known in advance to the controller 135.

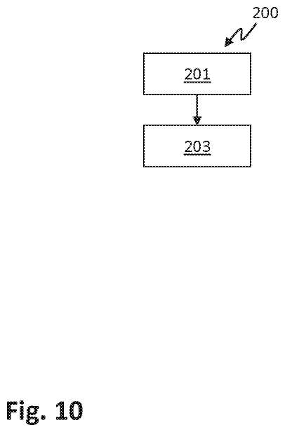

FIG. 10 shows a flowchart of a method 200 for operating a linear transport system 100 according to an embodiment.

In order to control the linear transport system 100, in a receiving step 201, the controller 135 first receives identifying information Id provided by the at least one first radio transmitting/receiving element 121 of the rotor 113 or the at least one second radio transmitting/receiving element 123 of the stator 111 and received by the respective other radio transmitting/receiving element 121, 123. The first or second radio transmitting/receiving element 121, 123 providing the identifying information Id may be uniquely identified via the identifying information Id.

In a first position information determining step 203, the controller 135 subsequently determines the first position information regarding the position of the rotor 113 relative to the stator 111 or regarding the position of the movable unit 101 relative to the stationary unit 103. In this context, the first position information defines the position range PB. The position range PB, in turn, defines a spatial region extending along the longitudinal axis LA of the rotor 113 or the stator 111. The position range PB delimits the position of the rotor 113 relative to the stator 111 or the movable unit 101 relative to the stationary unit 103.

According to the application, the absolute position AP of the rotor 113 relative to the stator 111 is located within the position range PB, in such a way that the position range PB may thus provide a coarse determination of the position of the rotor 113 relative to the stator 111 or of the movable unit 101 relative to the stationary unit 103. The position range PB is defined as a spatial range on a position scale of the stator 111 or the stationary unit 103 extending along the longitudinal axis LA.

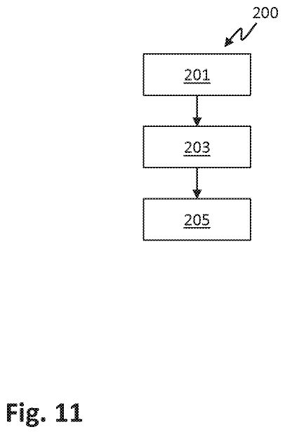

FIG. 11 shows a further flowchart of method 200 for operating a linear transport system 100 according to a further embodiment.

The embodiment of method 200 shown in FIG. 11 is based on the embodiment of FIG. 10 and comprises all the method steps described therein

In the embodiment shown, the controller 135 further determines, in an absolute position determining step 205, the absolute position AP of the rotor 113 relative to the stator 111 or of the movable unit 101 relative to the stationary unit 103, taking into account the first position information. As mentioned above, the absolute position is located within the position range PB and describes the absolute positioning of the movable unit 101 relative to the stationary unit 103. The absolute position AP may be used in the further course of controlling the linear transport system 100 to determine the position of the movable unit 101 relative to the stationary unit 103. The absolute position AP is defined as a position value on the position scale of the stator 111 or the stationary unit 103.

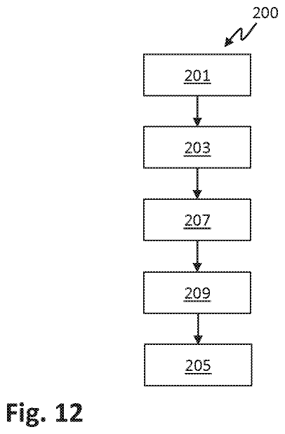

FIG. 12 shows another flowchart of method 200 for operating a linear transport system 100 according to a further embodiment.

The embodiment of method 200 shown in FIG. 12 is based on the embodiment shown in FIG. 11 and includes all of the method steps described therein.

In the shown embodiment, in a further receiving step 207, the controller 135 receives magnetic sensor data from at least one magnetic sensor element 133 of the stator 111. The magnetic sensor data represent magnetic field strengths of the rotor magnetic field generated by the magnet elements 119 of the rotor 113.

In a second position information determining step 209, the controller 135 determines, based on the magnetic sensor data, a second set of position information regarding the positioning of the rotor 113 relative to the stator 111.

In the absolute position determining step 205, the controller 135 subsequently determines the absolute position AP of the rotor relative to the stator 111 or of the movable unit 101 relative to the stationary unit 103, taking into account the first position information and the second position information.

According to an embodiment, the first position information describes the first relative position RP1 between at least a first radio transmitting/receiving element 121 of the rotor 113 and at least a second radio transmitting/receiving element 123 of the stator 111 that is in effective coupling and data communication with the first radio transmitting/receiving element 121 via a radio link 122. The first radio transmitting/receiving element 121 is embodied in the first position P1 at the rotor 113, while the second radio transmitting/receiving element 123 is embodied in the second position P2 at the stator 111.

The second position information further defines the second relative position RP2. As described above, the second relative position RP2 defines a projection of a magnetic sensor position MSP of the magnetic sensor elements 133 embodied at the stator 111 and receiving the magnetic sensor data onto the rotor 113. The second relative position RP2 thus describes the relative position of the magnetic sensor element 133, which receives the magnetic sensor data, with respect to at least one magnet element 119 of the rotor 113.

According to an embodiment, the first relative position RP1 describes the first position range PB1 of the first radio transmitting/receiving element 121 of the rotor 113, which is in active coupling and data communication with the second radio transmitting/receiving element 123 of the rotor 111. The projection of the second position P2 of the second radio transmitting/receiving element 123, which is in active coupling and data communication with the first radio transmitting/receiving element 121, onto the rotor 113 is positioned within the first position range PB1 of the respective first radio transmitting/receiving element 121. The first position range PB1 is, as shown in FIGS. 6A and 6B, FIG. 8, and FIG. 9, arranged around the first position P1 of the respective first radio transmitting/receiving element 121, which is in active coupling and data communication with the second radio transmitting/receiving element 123, and defines a spatial range within which the first radio transmitting/receiving element 121 and the second radio transmitting/receiving element 123 are in effective coupling and data communication between the two radio transmitting/receiving elements 121, 123 is enabled.

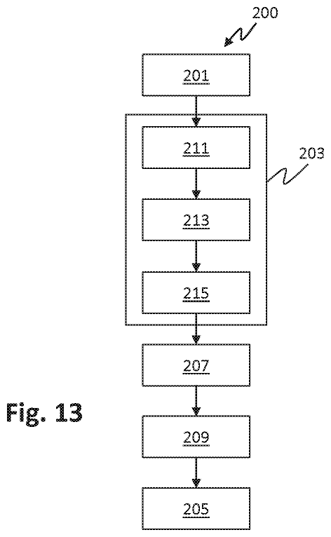

FIG. 13 shows a further flowchart of method 200 for operating a linear transport system 100 according to a further embodiment.

The embodiment in FIG. 13 is based on the embodiment in FIG. 12 and includes all the method steps described therein.

In the shown embodiment, in order to determine the first position information in the first position information determining step 203, in an identifying step 211, the controller 135 first identifies the first radio transmitting/receiving element 121 based on the received identifying information Id, which has exchanged the respective identifying information Id with the respective second radio transmitting/receiving element 123 of the stator 111 via data communication.

In a position determining step 213, the controller 135 subsequently determines the first position P1 at the rotor 113 of the first radio transmitting/receiving element 121 and the predefined second position P2 at the stator 111 of the second radio transmitting/receiving element 123, which is in active coupling and data communication with the first radio transmitting/receiving element 121.

In a first relative position determining step 215, the controller 135 subsequently determines the first relative position RP1 by taking into account the first and second positions P1, P2 and the first position range PB1 of the first and second radio transmitting/receiving elements 121, 123 that are in data communication.

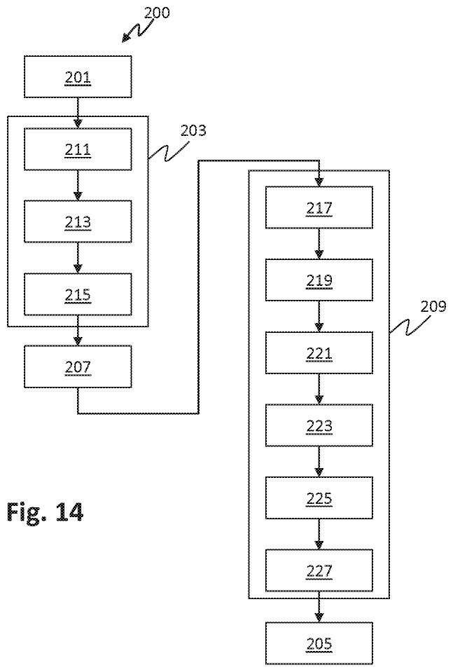

FIG. 14 shows a further flowchart of method 200 for operating a linear transport system 100 according to a further embodiment.

The embodiment of method 200 in FIG. 14 is based on the embodiment in FIG. 13 and comprises all the method steps described therein.

In the illustrated embodiment, in order to determine the second position information in the second position information determining step 209, the controller 135 carries out a magnetic field determining step 217 based on the magnetic sensor data from the at least one magnetic sensor element 133 of the stator 111, which represents the rotor magnetic field of the rotor 113, to determine at least a magnetic field strength of at least one magnet element 119 of the rotor 113 is determined.

The determined magnetic field strength may comprise a superposition of multiple magnetic field strengths of multiple magnet elements 119 of the rotor 113. The determined magnetic field strength may thus represent a magnetic field strength of a total magnetic field of a plurality of magnet elements 119 of the rotor 113 positioned within an effective range of the respective magnetic sensor element 133.

In a sensor distance determining step 219, the controller 135 determines the sensor distance SA along the longitudinal axis LA of the rotor 113 of the magnetic sensor element 123 to the at least one magnet element 119 based on the determined magnetic field strength and a known reference relationship between magnetic field strength and sensor distance SA. The sensor distance SA describes a distance along the longitudinal axis LA of the rotor 113 between the projection of the magnetic sensor position MSP of the respective magnetic sensor element 133 at the stator 111 onto the rotor 113 and one of the magnet elements 119 of the rotor 113.

The reference relationship between the detected magnetic field strength and the respective sensor distance SA may be based on reference measurements or on simulations.

As shown in FIG. 7, the magnet elements 119 of the rotor 113 may be arranged along the longitudinal axis LA with alternating opposite magnetic polarization directions. The sensor distance SA may in this context be defined with respect to a magnet element 119 having a magnetic north pole direction N or a magnet element 119 having a magnetic south pole direction S. As shown in FIG. 7, the sensor distance SA may define a relative positioning of the projection of the magnetic sensor position MSP of the respective magnetic sensor element 133 onto the rotor 113 within the magnet sectors MS1, MS2, MSn defined by the magnet elements 119 of the rotor 113.

In a distance determining step 221, the controller 135 subsequently determines a first distance D1 at the stator 111 between the second radio transmitting/receiving element 123 embodied at the second position P2 at the stator 111 and the magnetic sensor position MSP at the stator 111 of the at least one magnetic sensor element 133. The second position P2 of the second radio transmitting/receiving element 123, which communicates with the at least one first radio transmitting/receiving element 121 of the rotor 113, and the magnetic sensor position MSP of the magnetic sensor element 133, which receives the magnetic sensor data of the rotor magnetic field, are known to the controller 135. The first distance D1 between the two positions is thus also known to the controller 135 or may be calculated by it.

In a second position range determining step 223, the controller 135 subsequently determines the second position range PB2, taking into account the first position range PB1 and the first distance D1. The second position range PB2 determined by shifting the first position range PB1 along the longitudinal axis LA of the rotor 113 by the first distance D1.

The second position range PB2 thus corresponds in its dimensions to the first position range PB1 and is shifted at the rotor 113 by the first distance D1. According to the application, the second relative position RP2 is located within the second position range PB2. By shifting the first position range PB1, the absolute position of which at the rotor 113 is known to the controller 135, by the first distance D1, the absolute position of the second position range PB2 at the rotor 113 is also known to the controller 135.

In a magnet element position determining step 225, the controller 135 subsequently determines the magnet element position MEP of the respective magnet element 119, and the projection of the magnetic sensor position MSP of the magnetic sensor element 133 of the stator 111, which has recorded the magnetic sensor data of the rotor magnetic field, onto the rotor 113 has the sensor distance SA. The respective magnet element 119, for which the said projection of the magnetic sensor position MSP onto the rotor 113 exhibits the said sensor distance SA, is thereby identified as the magnet element 119 that is either located in the second position range PB2, or that comprises the smallest distance to the second position range PB2, possibly in a predetermined direction, along the longitudinal axis LA of the rotor 113. The corresponding magnet element position MEP of the magnet element 119 identified in this manner is known to the controller 135.

The magnet element position MEP of the magnet element 119 located in the second position range PB2 or positioned at the rotor 113 at the shortest distance from the second position range PB2 comprises a corresponding numerical value as absolute position information with respect to the position scale characteristic of the rotor.

Based on the magnet element position MEP of the respective magnet element 119 located in the second position range PB2 or positioned at the closest distance to the second position range PB2, as determined in this manner, the second relative position RP2 may subsequently be converted into absolute position information relative to the position scale of the rotor 113, taking into account the sensor distance SA.

For this purpose, in a second relative position determining step 227, the controller 135 determines the second relative position RP2 or converts it into absolute position information relative to the position scale of the rotor 113, in which the controller 135 adds the sensor distance SA along the longitudinal axis LA of the rotor 113 to the magnet element position MEP of the magnet element 119, which is located in the second position range PB2 or positioned at the minimum distance therefrom.

The second relative position RP2, defined in this manner as absolute position information relative to the position scale of the rotor 113, may thus be used to precisely determine absolute position information relative to the position scale of the rotor 113 for the projection of the magnetic sensor position MSP of the magnetic sensor element 133 of the rotor 111, which provides the magnetic sensor data of the rotor magnetic field.

By describing the second relative position RP2 in the form of absolute position information relative to the position scale of the rotor 113, it is thus possible to precisely determine in which magnet sector MS1, MS2, MSn of the magnet elements 119 of the rotor 113 the projection of the magnetic sensor position MSP of the respective magnet element 133 of the stator 111 is located. In other words, by calculating the second relative position RP2 in the form of absolute position information relative to the position scale of the rotor 113, the specific magnet element 119 that is represented by the magnetic sensor data of the respective magnetic sensor element 133 may be precisely determined.

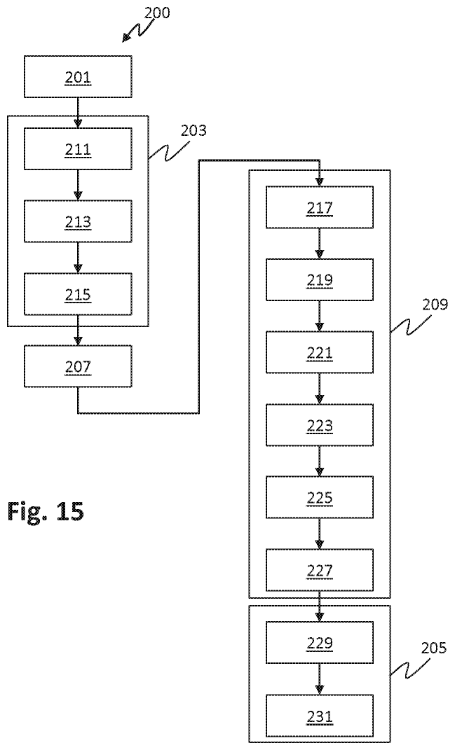

FIG. 15 shows a further flowchart of method 200 for operating a linear transport system 100 according to a further embodiment.

The embodiment of method 200 shown in FIG. 15 is based on the embodiment in FIG. 14 and includes all of the method steps described therein.

In the embodiment shown, the absolute position AP is defined as the positioning of the first position marker PM1 of the rotor 113 relative to the second position marker PM2 of the stator 111. In order to determine the absolute position AP in the absolute position determining step 205, the controller 135 first determines, in a distance determining step 229, the second distance D2 of the second relative position RP2 at the rotor 113 along the longitudinal axis LA to the predefined first position marker PM1.

With the aid of the preceding method steps, the second relative position RP2 has been described in the form of absolute position information with respect to the position scale of the rotor 113. The second relative position RP2 is thus defined as a numerical value with respect to the position scale of the rotor 113. The controller 135 is thereby able to calculate a distance between the absolute position information of the second relative position RP2 and the absolute position information of the first position marker PM1.

In an adding step 231, the controller 135 subsequently adds the previously calculated second distance D2 to the magnetic sensor position MSP of the magnetic sensor element 133, which provides the sensor data of the rotor magnetic field, along the longitudinal axis LA of the stator 111. Adding the second distance D2 to the magnetic sensor position MSP of the magnetic sensor element 133 results in a projection of the first position marker PM1 of the rotor 113 onto the stator 111.

The projection of the first position marker PM1 onto the stator 111, calculated in this manner, provides absolute position information regarding the second position marker PM2 of the stator 111 and the projection of the first position marker PM1 of the rotor 113 relative to the position scale of the stator 111. Based on this, the absolute position AP of the rotor 113 relative to the stator 111, or of the movable unit 101 relative to the stationary unit 103, may be determined as the positioning of the projection of the first position marker PM1 of the rotor 113 onto the stator 111 relative to the second position marker PM2 of the stator 111.

The absolute position AP provides absolute position information of the rotor 113 relative to the stator 111 with respect to the position scale of the stator 111 or the stationary unit 103. The absolute position AP is thus assigned a numerical value from the position scale of the stator 111 or the stationary unit 103 and describes, with respect to the position scale of the stator 111, the absolute positioning of the rotor 113 relative to the stator 111 or the movable unit 101 relative to the stationary unit 103.

According to an embodiment, the first position determining step 203 is carried out while the movable unit 101 is held relative to the stationary unit 103. The absolute position AP, determined by the position-detecting system 109 taking into account the first position information determined in the first position determining step 203, may thus be used as an absolute starting position for a subsequent position determination of the movable unit 101 relative to the stationary unit 103. When the movable unit 101 is moved relative to the stationary unit 103, an absolute position determination of the rotor 113 relative to the stator 111 or of the movable unit 101 relative to the stationary unit 103 may be achieved based on the absolute position AP as an initial position in the functionality of an incremental encoder with the aid of further measurements of the rotor magnetic field via the magnet sensor element 133 of the stator 111.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

| | |
|---|---|
| 121 | first radio transmitting/receiving element |
| 121-1 | first first radio transmitting/receiving element |
| 121-2 | second first radio transmitting/receiving element |
| 121-3 | third first radio transmitting/receiving element |
| 121-4 | fourth first radio transmitting/receiving element |
| 121-(n-1) | (n-1)-th first radio transmitting/receiving element |
| 121-n | nth first radio transmitting/receiving element |
| 123 | second radio transmitting/receiving element |
| 125 | printed circuit board |
| 127 | functional module |
| 129 | application |
| 131 | energy-transmitting coil |
| 133 | magnetic sensor element |
| 135 | controller |
| 141 | data line |
| 155 | gap |
| 165 | motor module housing |
| 167 | coil core |
| 169 | first end |
| 171 | second end |
| 173 | first magnetic sensor element |
| 175 | second magnetic sensor element |
| 177 | first magnet element |
| 179 | second magnet element |
| 181 | third magnet element |
| 183 | fourth magnet element |
| 185 | outer edge |
| 187 | cover element |
| 200 | method |
| 201 | receiving step |
| 203 | first position information determining step |
| 205 | absolute position determining step |
| 207 | further receiving step |
| 209 | second position information determining step |
| 211 | identifying step |
| 213 | position determining step |
| 215 | first relative position determining step |
| 217 | magnetic field determining step |
| 219 | sensor distance determining step |
| 221 | distance-determining step |
| 223 | second position range determining step |
| 225 | magnet element positioning step |
| 227 | second relative position determining step |
| 229 | distance determining step |
| 231 | adding step |

TABLE 2
List of reference symbols

A1 distance between two radio transmitting/receiving elements
A2 distance between two magnet elements

| | |
|---|---|
| AA1 first magnetic sensor element distance | AA2 second magnetic sensor element spacing |

AB second radio transmitting/receiving element spacing

| | |
|---|---|
| L size of a first radio transmitting/receiving element | L_{L} stator length |
| L_{M} coil length | L_{S} gap length |
| P position of rotor relative to stator | PB position range |

P1 initial position of first radio transmitting/receiving element
P1-1 first position of first radio transmitting/receiving element
P1-2 second first position of second first radio transmitting/receiving element
P1-3 third first position of third first radio transmitting/receiving element
P1-4 fourth first position of fourth first radio transmitting/receiving element
P1-(n-1) (n-1)-th first position of (n-1)-th first radio transmitting/receiving element
P1-n nth first position of nth first radio transmitting/receiving element
P2 second position of second radio transmitting/receiving element

| | |
|---|---|
| PB1 first position range | PB2 second position range |

PB1-1 first position range of first radio transmitting/receiving element
PB1-2 second first position range of second first radio transmitting/receiving element
PB1-3 third first position range of third first radio transmitting/receiving element
PB1-4 fourth first position range of fourth first radio transmitting/receiving element
PB1-(n-1) first position range of (n-1)-th first radio transmitting/receiving element
PB1-n first position range of nth first radio transmitting/receiving element

| | |
|---|---|
| MSP magnetic sensor position | MEP-1 first magnet element position |
| MSP1 first magnetic sensor position | MEP-2 second magnet element position |
| MSP2 second magnetic sensor position | MEP-3 third magnet element position |
| PL1 first rotor position | MEP-4 fourth magnet element position |
| PL2 second rotor position | MEP-5 fifth magnet element position |
| RP1 first relative position | MEP-(n-2) (n-2)-th magnet element position |
| RP2 second relative position | MEP-(n-1) (n-1)-th magnet element position |
| MEP magnet element position | MEP-n nth magnet element position |

TABLE 3
List of directional and identification symbols

| | |
|---|---|
| R direction of motion | MS magnet sector |
| φₑₗ electrical angle | MS1 first magnet sector |
| S magnetic south direction | MS2 second magnet sector |
| N magnetic north direction | MSn nth magnet sector |
| Z1 center of radio transmitting/receiving | Z2 center of magnet element |
| element | |
| LA longitudinal axis | AP absolute position |
| SA sensor distance | Id identifying information |

1. A linear transport system comprising:
a movable unit,
a stationary unit having a guide rail for guiding the movable unit,
a linear motor for driving the movable unit along the guide rail, and
a position-detecting system;
wherein the linear motor comprises a stator and a rotor,
wherein the stator is embodied at the stationary unit and comprises a plurality of motor modules arranged in a stationary manner along the guide rail and comprising drive coils and magnetic sensor elements, and
wherein the rotor is arranged at the movable unit and comprises a plurality of magnet elements;
wherein the position-detecting system comprises:
at least a first radio transmitting/receiving element and a second radio transmitting/receiving element,
wherein the first radio transmitting/receiving element is embodied at the rotor in a predefined first position,
wherein the second radio transmitting/receiving element is embodied at the stator in a predefined second position, and
wherein the first radio transmitting/receiving element and the second radio transmitting/receiving element are each configured to provide and/or read out identifying information;
wherein the identifying information is provided by the first radio transmitting/receiving element or the second radio transmitting/receiving element by reading out the respective other radio transmitting/receiving element,
wherein first position information regarding a position of the rotor relative to the stator is determinable, and
wherein, taking the first position information into account, a position range regarding the positioning of the rotor relative to the stator is determinable.

2. The linear transport system according to claim 1, wherein:
a second position signal regarding the position of the rotor relative to the stator is determinable by measuring of magnetic field strengths of the magnet elements of the rotor by at least a magnet sensor element of the stator is determinable, and
wherein an absolute position of the rotor relative to the stator is determinable by taking into account the first position information and the second position information.

3. The linear transport system according to claim 1, wherein:
the position-determining system is embodied as a near-field communication system, and
wherein the first radio transmitting/receiving element and the second radio transmitting/receiving element are each configured as a near-field communication transmitting/receiving element or as a near-field communication read element.

4. The linear transport system according to claim 1, wherein:
the position-determining system comprises a plurality of first radio transmitting/receiving elements and/or second radio transmitting/receiving elements, and
wherein the first radio transmitting/receiving elements are each embodied at predefined first positions at the rotor and/or the second radio transmitting/receiving elements are embodied at predefined second positions at the stator.

5. The linear transport system according to claim 4, wherein:
the first radio transmitting/receiving elements are each configured to provide identifying information readable by the second radio transmitting/receiving element and is characteristic of the respective first radio transmitting/receiving element; and/or
wherein the second radio transmitting/receiving element is set up to provide identifying information readable by the first radio transmitting/receiving elements and characterizes the respective second radio transmitting/receiving element, and
wherein the characteristic identifying information allows for a unique identification of the respective first radio transmitting/receiving element or second radio transmitting/receiving element.

6. The linear transport system according to claim 3, wherein:
the first radio transmitting/receiving elements are configured to be individually read out by the second radio transmitting/receiving element and/or the second radio transmitting/receiving element is configured to be individually read out by the first radio transmitting/receiving elements.

7. The linear transport system according to claim 4, wherein the first radio transmitting/receiving elements are embodied side-by-side at the rotor along a longitudinal axis of the movable unit.

8. The linear transport system according to claim 7, wherein:
along the longitudinal axis, a distance between two adjacent first radio transmitting/receiving elements is smaller than a minimum distance between two magnet elements having the same magnetic polarity, and/or
wherein a width of the first radio transmitting/receiving elements along the longitudinal axis is smaller than the smallest distance between two magnet elements having the same magnetic polarity.

9. The linear transport system according to claim 1, wherein:
the first radio transmitting/receiving elements are arranged in two spaced-apart rows at the rotor, and
wherein the magnet elements of the rotor are arranged in a region between the two spaced-apart rows.

10. The linear transport system according to claim 1, wherein the first radio transmitting/receiving elements and/or the magnet elements are arranged on a common printed circuit board.

11. The linear transport system according to claim 1, wherein:
the first radio transmitting/receiving element comprises an identification identifier readable by the second radio transmitting/receiving element, and
wherein the movable unit is configured to be uniquely identified via the identification code.

12. A computer-implemented method for operating a linear transport system according to claim 1, comprising:
receiving an identifying information of the respective other radio transmitting/receiving element read out by the first radio transmitting/receiving element or the second radio transmitting/receiving element via the controller of the linear transport system in a receiving step; and
determining first position information regarding a position of the rotor relative to the stator based on the identifying information via the controller in a first position information determining step, wherein the first position information defines a position range regarding the positioning of the rotor relative to the stator.

13. The computer-implemented method according to claim 12, further comprising:
receiving magnetic sensor data from at least one magnetic sensor element regarding magnetic field strengths of at least one magnet element of the rotor by the controller in a further receiving step;
determining second position information regarding the positioning of the rotor relative to the stator based on the magnetic sensor data by the controller in a second position information determining step;
determining an absolute position of the rotor relative to the stator based on the first position information and the second position information by the controller in an absolute position determining step.

14. The computer-implemented method according to claim 13, wherein:
the first position information defines a first relative position between the first radio transmitting/receiving element and the second radio transmitting/receiving element, and
wherein the second position information defines a second relative position of at least one magnetic sensor element of the stator relative to at least one magnet element of the rotor.

15. The computer-implemented method according to claim 14, wherein:
the first relative position describes a position at the rotor of a projection onto the rotor of the second radio transmitting/receiving element embodied at the second position at the stator, and is defined by a first position region extending along the longitudinal axis of the rotor and arranged around the first position,
wherein the first position region defines a spatial region in which the first radio transmitting/receiving element arranged at the first position at the rotor and the second radio transmitting/receiving element arranged at the second position at the stator are in mutual effective coupling with one another, and/or
wherein the second relative position describes a position at the rotor of a projection onto the rotor of the magnetic sensor element embodied in a magnetic sensor position at the stator.

16. The computer-implemented method according to claim 12, wherein the first position information determining step comprises:
identifying the first radio transmitting/receiving element based on the identifying information by the controller in an identifying step;
determining the predefined first position at the rotor of the first radio transmitting/receiving element identified in the identifying step and determining the predefined second position at the stator of the second radio transmitting/receiving element by the controller in a position determining step; and
determining the first relative position of the first radio transmitting/receiving element located at the first position relative to the second radio transmitting/receiving element located at the second position at the stator, taking into account the first and second positions and the first position range via the controller in a first relative position determining step.

17. The computer-implemented method according to claim 12, wherein the second position information determining step comprises:
determining a magnetic field strength of at least one magnet element of the rotor based on the magnetic sensor data of the at least one magnetic sensor element of the stator via the controller in a magnetic field determining step;
determining a sensor distance along the longitudinal axis of the rotor of the magnetic sensor element with regard to the at least one magnet element based on the determined magnetic field strength and a previously known reference relationship between magnetic field strength and sensor distance via the controller in a sensor distance determining step;
determining a first distance at the stator between the second radio transmitting/receiving element embodied in the second position at the stator and the pre-known magnetic sensor position at the stator of the at least one magnetic sensor element via the controller in a distance determining step;
determining a second position range at the rotor by shifting the first position range arranged around the first position by the first distance along the longitudinal axis at the rotor via the controller in a second position range determining step;
determining a magnet element position at the rotor of the at least one magnet element as the magnet element position of one of the magnet elements of the rotor, which is located in the second position range or comprises the smallest distance along the longitudinal axis of the rotor to the second position range, via the controller in a magnet element position determining step;
determining the second relative position by adding the sensor distance along the longitudinal axis of the rotor between the magnetic sensor element and the at least one magnet element measured by the magnetic sensor element to the magnet element position of the at least one magnet element at the rotor by the controller in a second relative position determining step.

18. The computer-implemented method according to claim 12, wherein:
the absolute position of the rotor relative to the stator is defined as the positioning of a predefined first position marker at the rotor relative to a second position marker at the stator, and wherein the absolute position determining step comprises:
determining a second distance of the second relative position at the rotor to the predefined first position marker at the rotor via the controller in a distance determining step;
determining the absolute position of the rotor relative to the stator via the controller by adding the second distance to the magnetic sensor position of the magnetic sensor element at the stator with respect to the previously known second position marker at the stator via the controller in a adding step.

19. The computer-implemented method according to claim 12, wherein the first position determining step is carried out while the movable unit is stationary.
